(19) United States
(12) Patent Application Publication
(10) Pub. No.: US 2007/0219770 A1
(43) Pub. Date: Sep. 20, 2007

(54) Simulation method

(76) Inventors: Peter Maurice Lee, Tokyo (JP); Junji Sato, Tokyo (JP); Goichi Yokomizo, Tokyo (JP)

Correspondence Address: MILES & STOCKBRIDGE PC, 1751 PINNACLE DRIVE, SUITE 500, MCLEAN, VA, 22102-3833, US

(21) Appl. No.: 11/497,301

(22) Filed: Aug. 2, 2006

(30) Foreign Application Priority Data
Aug. 3, 2005 (JP) 2005-225019

(51) Int. Cl. G06F 17/50

(52) U.S. Cl. 703/14

(57) ABSTRACT

A simulation method can be provided which hardly generates a voltage source loop, the method includes: a first process which conducts simulation in which a circuit node at a higher level layer of layered circuit data is set to a result output node and stores a result; and a second process which uses a simulation result stored in the first process as input/output information about a circuit area including a circuit node at a lower level layer and conducts simulation for the circuit node at the lower level layer lower than the higher level layer, wherein when a circuit area to be a target for the second process has a sub-circuit configured of any one device of a voltage source and an inductor or configured of at least two of devices having a voltage source and an inductor joined to each other and has one or more of external nodes which connect the sub-circuit to an outside, and when the sub-circuit is connected to a ground potential, input/output information to be given to the external node in the second process is set to current information.

### CLAIM OF PRIORITY

The Present application claims priority from Japanese application JP 2005-225019 filed on Aug. 3, 2005, the content of which is hereby incorporated by reference into this application.

### FIELD OF THE INVENTION

The present invention relates to a data processing method typified by a circuit simulation method, and a simulation program, which relate to a technique effectively applicable to a simulator for use in development or design of a semiconductor integrated circuit, for example.

### BACKGROUND OF THE INVENTION

A circuit simulation technique is used for a circuit verification technique in the circuit design and layout design of semiconductor integrated circuits. With the larger scale and higher density packing of circuits in association with recent miniaturization of devices, increases in the execution time for circuit simulation and the data volume of the simulation results become obvious. In actual circuit simulation processing, a designer selectively specifies information desired to confirm as an output, and conducts simulation processing. Only the specified information is stored as resulting data. Therefore, the resulting data not stored cannot be shown as the result. In order to allow showing a given result, it is necessary that all the circuit nodes to be targets for simulation are specified to conduct simulation and the results are stored. In a large-scale circuit, the data volume becomes enormous when all the items of resulting data are stored, and it is substantially impossible to store all the items of data. In addition, when the data volume of the target for showing the results is increased, the retrieval time for resulting data is grown to slow down the display speed. Moreover, in the large-scale circuit, since the simulation processing time is increased, the time required for resimulation coping with a partial change in a circuit or a change in device parameters is also grown.

Relating to a reduction in a storage area to store simulation results, Patent Reference 1 describes a technique in which simulation results are compressed and stored, and Patent Reference 2 discloses a technique in which a circuit is split from the upstream toward the downstream of a signal path to partially conduct simulation in consideration of the influence of outputs of the split circuits.

However, in the technique described in Patent Reference 1, compression and decompression are newly required, and thus the computer processing time in association with simulation and showing results is further increased. In the technique described in Patent Reference 2, even though the memory volume for use in computer processing is reduced, the storage capacity of an auxiliary storage module to store the results is not reduced yet. In addition to this, the circuit needs to be split so as not to depend on the other simulation results and to sequentially undergo simulation processing.

Thus, it can be considered that the processing time tends to increase.

Then, the applicant filed a patent application before (Patent Reference 1). A simulation method according to the application before includes: a first process which conducts simulation in which a circuit node at a higher level layer of layered circuit data is set to a result output node and stores a result; and a second process which uses a simulation result stored in the first process as input/output information about a circuit area including a circuit node at a lower level layer and conducts simulation for the circuit node at the lower level layer lower than the higher level layer under a predetermined initial condition.

Patent Reference 1: JP-A-11-96207

Patent Reference 2: JP-A-9-259151

Patent Reference 3: Brochure of W003/036523

### SUMMARY OF THE INVENTION

The inventor further investigated the invention according to the application before, and focused attention on the case in which a voltage source loop is generated in simulation. In the case in which there is a path that is connected only to at least one of a voltage source and an inductor in simulation, when a voltage source or a ground is connected to the both ends of the path to form a loop, it is likely to generate such a defect that a contradiction occurs in the voltage of a node included in the path, or that no current value can be obtained. The loop configured only of such a voltage source and an inductor is called a voltage source loop. When a voltage source loop is generated in a simulation target circuit, simulation results might not be obtained. The inventor found a necessity to prepare a scheme beforehand that copes with the possibility of generating a voltage source loop in simulation for a lower layer also in the application before.

An object of the invention is to provide a simulation method which can show data at a given point to output a result even though all the items of simulation resulting data are not stored for a large-scale simulation target and which hardly generates a defect caused by a voltage source loop.

The above object, other objects and novel features of the invention will be apparent from the description below and the accompanying drawings of the specification.

Among the inventions to be disclosed in the present application, the brief description of the outline of typical ones is as follows.

1. 1-A

A simulation method according to the invention includes: a first process which conducts simulation in which a circuit node at a higher level layer of layered circuit data is set to a result output node and stores a result; and a second process which uses a simulation result stored in the first process as input/output information about a circuit area including a circuit node at a lower level layer and conducts simulation for the circuit node at the lower level layer lower than the higher level layer under a predetermined initial condition. Desirably, the predetermined initial condition may be an initial condition equivalent to that of simulation in the first process. For example, the initial condition may be stored along with the simulation result in the first process, and available for reuse. Thus, since the result output node in which the simulation result is stored is limited to that at the higher level layer, the volume of the resulting data to be stored in simulation can be reduced. For the circuit node at the lower level layer, the simulation result is not stored as the result output node, but the resulting data of the result output node at the higher level layer serves as the information interface to the circuit node at the lower level layer, and the simulation condition of the first process provides the initial state for the internal circuit node at the lower level layer. Therefore, in response to a showing instruction that requires more data in addition to the resulting data obtained in the first process, the result may be shown that is obtained from partial resimulation in the second process. Accordingly, a small storage capacity (the capacity that can store the resulting data in the first process) can achieve data showing performance equivalent to the case of storing all the items of simulation resulting data for a large-scale simulation target such as a large-scale integrated circuit. A reduction in the resulting data volume to be stored can shorten the retrieval time for resulting data. In addition, since the scale of the target circuit in resimulation by the second process can be reduced, the resimulation time can be shortened when a partial change in a circuit or a change in device parameters is made in a large-scale circuit.

1-B

At this time, when a circuit area (3p) to be a target for the second process has a sub-circuit (VLC) configured of any one device of a voltage source (Vs) and an inductor (Lt) or configured of at least two of devices having a voltage source and an inductor joined to each other and has one or more of external nodes (N1 to NN) which connect the sub-circuit to an outside, and when the sub-circuit is connected to a ground potential (GND), input/output information to be given to the external node in the second process is set to current information (IN1 to INN) (FIG. 38). The current information is given as a required current source. In simulation, even though there is a sub-circuit in which at least one device of the voltage source and the inductor is only connected as a circuit device, the reference point of potential of the sub-circuit is defined by the ground potential, and current information is given to the external node of the sub-circuit, whereby the possibility is eliminated that generates a voltage source loop by providing voltage information to the external node, and the necessary simulation result can be obtained. In order to acquire the current information, this scheme may be done in which the voltage source having zero voltage is connected to one of the external nodes to determine the current carried through the device in the first process, and it is stored for reuse in the second process.

In addition, when a circuit area to be a target for the second process has a sub-circuit (VLCv) configured of a single voltage source or configured of at least two of voltage sources joined to each other, one or more of external nodes which connect the sub-circuit to an outside and another circuit (CIR) connected to the sub-circuit, and when the sub-circuit is connected to a ground potential, input/output information to be given to all the external nodes of the sub-circuit (VLCv) in the second process is set to current information (FIG. 42). When another circuit is further connected to the sub-circuit, the voltage value of the external nodes of the sub-circuit is decided by the state of that another circuit. Thus, all the external nodes may be floated in the first place. This is done in order that no voltage source loop is generated in any cases. When it is desired to verify the current carried through the voltage source of the sub-circuit by simulation, current information may be given as input/output information to all the external nodes of the sub-circuit (VLCv). The current information may be determined as similar to the description above.

In addition, when a circuit area to be a target for the second process has a sub-circuit configured of a single voltage source or configured of two or more of voltage sources joined to each other, one or more of external nodes which connect the sub-circuit to an outside and another circuit connected to the sub-circuit, and when the sub-circuit is connected to a ground potential, all the external nodes are floated when a current carried through the voltage source of the sub-circuit is not observed in the second process (FIG. 41). It can be said that when it is unnecessary to verify the current carried through the voltage source of the sub-circuit by simulation, the external nodes other than the external node directly joined to another circuit may be floated.

In addition, when a circuit area to be a target for the second process has a sub-circuit configured of any one device of a voltage source and an inductor or configured of at least two of devices having a voltage source and an inductor joined to each other and has one or more of external nodes which connect the sub-circuit to an outside, and when the sub-circuit is connected to a ground potential, the sub-circuit is deleted when a current carried through all the devices of the sub-circuit is not observed in the second process (FIG. 43). In short, it can be said that when it is unnecessary to verify the current carried through all the devices of the sub-circuit by simulation, the sub-circuit may be deleted to conduct simulation. It contributes to a reduction in circuit information for simulation and a shortened computer processing time.

1-C

In the explanation above, the sub-circuit is considered to be connected to the ground potential, but it is not required necessarily. When a circuit area to be a target for the second process includes a sub-circuit configured of any one device of a voltage source and an inductor or configured of at least two of devices having a voltage source and an inductor joined to each other and includes two or more of the external nodes which connect the sub-circuit to an outside, and when the sub-circuit is not connected to a ground potential, input/output information to be given to one of two or more of the external nodes in the second process is set to voltage source information, and input/output information to be given to the remaining external nodes is set to current source information (FIG. 46). For example, voltage source information as input/output information to be given to one of the external nodes is considered to be information equivalent to the ground potential in the description above.

Similarly, when a circuit area to be a target for the second process includes a sub-circuit configured of a single voltage source or configured of at least two of voltage sources joined to each other, two or more of the external nodes which connect the sub-circuit to an outside and another circuit connected to the sub-circuit, and when the sub-circuit is not connected to a ground potential, input/output information to be given to one external node in the second process is set to voltage source information, and input/output information to be given to the remaining external nodes is set to current source information (FIG. 49).

Still similarly, when a circuit area to be a target for the second process includes a sub-circuit configured of a single voltage source or configured of two or more of voltage sources joined to each other, two or more of the external nodes which connect the sub-circuit to an outside and another circuit connected to the sub-circuit, and when the sub-circuit is not connected to a ground potential, input/output information to be given to one external node is set to voltage source information, and the remaining external nodes are floated when a current carried through the voltage source of the sub-circuit is not observed in the second process (FIG. 48).

Similarly, when a circuit area to be a target for the second process has a sub-circuit configured of any one device of a voltage source and an inductor or configured of at least two of devices having a voltage source and an inductor joined to each other and has one or more of external nodes which connect the sub-circuit to an outside, and when the sub-circuit is not connected to a ground potential, the sub-circuit is deleted when a current carried through all the devices of the sub-circuit is not observed in the second process.

1-D

In the first process, when a value of the voltage source or the current source to be connected to the result output node depends on a value of a circuit node or a state of a circuit device at a lower level layer, information about the value of the circuit node or the circuit device at the lower level layer is also stored (FIG. 28). Even though the higher layer has the dependent relationship on the lower layer, layered simulation according to the method can be conducted which can shorten the simulation time.

2.

A simulation method according to another viewpoint of the invention includes: an extracting process which extracts a circuit node at a specified higher level layer from layered circuit data; and a simulation execution process which conducts circuit simulation in which a circuit node extracted in the extracting process is set to a result output node. The method also includes: a storage process which stores resulting data obtained at the result output node by the simulation execution process; and a simulation re-execution process which acquires input/output information that is done outside a circuit area including a circuit node from the stored resulting data for the circuit node at a lower level layer than the specified layer and conducts circuit simulation. Also in this case, a simulation method is configured in which the simulation re-execution process includes a process relating to a sub-circuit which eliminates the possibility of generating a voltage source loop described in 1-A, 1-B, and 1-C above. Moreover, as described in 1-D, the similar scheme can be taken for the case in which the higher layer has a dependent relationship on the lower layer.

In addition, as a specific form of the invention, a showing process may be further included which shows resulting data stored in the storage process or a simulation result obtained in the simulation re-execution process in response to an instruction to show a result from simulation processing.

For example, the extracting process may be a process which conducts a process for all reference lines in a simulation target, the process being to register a circuit node trackable at a set layer level at every time when the setting of a layer level is changed to a lower level while a reference line to a lower layer is followed in layered circuit data. The result output node by simulation can be extracted by specifying a layer.

3.

A simulation method according to still another viewpoint of the invention includes: a simulation execution process which uses layered circuit data to conduct a circuit simulation process; and a storage process which stores resulting data obtained at a predetermined circuit node by the simulation execution process. The method also includes: a simulation re-execution process which acquires input/output information that is done outside a circuit area including a circuit node from resulting data stored in the storage process for the circuit node that its state is changed by alteration when the layered circuit data is altered, and conducts circuit simulation. Also in this case, a simulation method is configured in which the simulation re-execution process includes a process relating to a sub-circuit which eliminates the possibility of generating a voltage source loop described in 1-A, 1-B, and 1-C above.

4.

A simulation method according to yet another viewpoint of the invention includes: a first process which extracts a result output point at a specified higher level layer from a simulation target; a second process which conducts simulation relating to the extracted result output point; and a third process which stores resulting data obtained at the result output point in the second process. The method also includes: a fourth process which acquires border information about an area including the result output point at the lower level layer from resulting data stored in the third process in response to an instruction to show a result from simulation processing for a lower level layer than the specified layer, and conducts simulation in order to obtain a result output at the lower level layer under an initial condition equivalent to that of simulation in the second process. Also in this case, a simulation method is configured in which the simulation re-execution process includes a process relating to a sub-circuit which eliminates the possibility of generating a voltage source loop described in 1-A, 1-B, and 1-C above. Moreover, as described in 1-D, the similar scheme can be taken for the case in which the higher layer has a dependent relationship on the lower layer.

### BRIEF DESCRIPTION OF THE DRAWINGS

FIG. 1 shows an illustration depicting the concept of a simulation method according to the invention along with exemplary result output sections;

FIG. 2 shows an illustration depicting the concept of the simulation method further in principles according to the invention;

FIG. 3 shows an illustration depicting the principle of the simulation method according to the invention, focusing attention on the layer structure of layered circuit data;

FIG. 4 shows an illustration depicting an exemplary state in which a partial change in a circuit or a change in device parameters is made in a simulation target circuit;

FIG. 5 shows an illustration depicting an exemplary scheme which obtains a simulation result having a change reflected when a partial change in a circuit or a change in device parameters is made;

FIG. 6 shows an illustration depicting the principle of the simulation method which copes with the partial change shown in FIG. 5, focusing attention on the layer structure of layered circuit data;

FIG. 7 shows an illustration depicting exemplary parallel processing of on-the-fly simulation;

FIG. 8 shows an illustration depicting exemplary parallel processing of simulation similar to on-the-fly simulation for a sub-area caused by a change in a circuit;

FIG. 9 shows a block diagram depicting an exemplary data processing system which implements the simulation method according to the invention;

FIG. 10 shows a flow chart depicting an exemplary circuit simulation process done by a circuit simulator 10 shown in FIG. 9;

FIG. 11 shows a flow chart depicting exemplary control of showing simulation results done by a result showing control module and a sub-circuit simulation control module shown in FIG. 9;

FIG. 12 shows a block diagram depicting a detailed exemplary result showing control module having an on-the-fly simulation function configured of the sub-circuit simulation control module and the result showing control module shown in FIG. 9;

FIG. 13 shows an illustration depicting an exemplary layer structure of circuit data with a layer structure;

FIG. 14 shows a conceptual diagram depicting the relationship between the layer structure and the layer level of circuit blocks shown in FIG. 13;

FIG. 15 shows an information format diagram depicting exemplary information held by the circuit blocks in each layer in the layered circuit data explained in FIG. 3 and the other drawings;

FIG. 16 shows an illustration depicting an exemplary form of the circuit block formed only of lower level blocks and information thereof;

FIG. 17 shows an illustration depicting an exemplary form of the circuit block formed of a lower level block and a device and information thereof;

FIG. 18 shows an illustration depicting an exemplary form of the circuit block formed only of devices and information thereof;

FIG. 19 shows a format diagram depicting an exemplary typical data format of the layered items of circuit block information and the layer levels of the entire simulation target circuit;

FIG. 20 shows an information format diagram when node information about an external connecting node and an internal connecting node is extracted from circuit block information in an exemplary data form shown in FIG. 19;

FIG. 21 shows an illustration depicting a specific example of the layered items of circuit block information and the layer levels of the entire simulation target circuit having the layer structure shown in FIG. 13;

FIG. 22 shows an illustration depicting node information having all the node names with layer information extractable from the circuit block information shown in FIG. 21;

FIG. 23 shows a flow chart depicting exemplary control over a result output node extracting process;

FIG. 24 shows an illustration depicting exemplary locations of node information extracted when the extracting process shown in FIG. 23 is performed where the specified layer level is 2 for the layered items of circuit block information shown in FIG. 21;

FIG. 25 shows an illustration depicting exemplary node information in a thick rectangular frame which is extracted for the node name with layer information shown in FIG. 22 in the extracting process shown in FIG. 23;

FIG. 26 shows a conceptual diagram depicting the case in which simulation results are created in on-the-fly simulation for nodes X1, X1 and N1 with layer information in the circuit shown in FIG. 13;

FIG. 27 shows an illustration depicting an example that the result output node extracting processing module is isolated from the circuit simulator 10;

FIG. 28 shows an illustration depicting the concept of the simulation method for the case in which when a current source and a voltage source in a higher layer depend on the value of an internal node or the state of an internal device in a lower layer, the value of the internal node and information about the internal device are stored as well;

FIG. 29 shows a process flow depicting circuit simulation in the case shown in FIG. 28;

FIG. 30 shows an illustration depicting an exemplary layer structure of layered circuit data when resulting data has lower layer dependence;

FIG. 31 shows an illustration depicting an exemplary state in which all the items of node information about the external connecting nodes and the internal connecting nodes extracted from the circuit block information shown in FIG. 21 are given as node names with layer information in the case shown in FIG. 30;

FIG. 32 shows a flow chart depicting an exemplary control flow of a result output node extracting process in the case shown in FIG. 30;

FIG. 33 shows an illustration depicting exemplary locations of node information extracted when the extracting process shown in FIG. 32 is performed where the specified layer level is 2;

FIG. 34 shows an illustration depicting node names with layer information extracted and registered as shown in FIG. 32 as distinguished by a thick frame;

FIG. 35 shows a system block diagram depicting the case in which a result output node and device extracting processing module is isolated from the circuit simulator;

FIG. 36 shows a conceptual diagram depicting a first example that is focused attention as the form likely to generate a voltage source loop;

FIG. 37 shows an illustration depicting the case in which a sub-circuit VLC forms a voltage source loop in a circuit area 3p shown in FIG. 36;

FIG. 38 shows a conceptual diagram depicting an exemplary circuit state that suppresses the generation of a voltage source loop in on-the-fly simulation for the circuit area 3p shown in FIG. 36;

FIG. 39 shows an illustration depicting a scheme to determine current information about nodes N1 to NN;

FIG. 40 shows a conceptual diagram depicting the case in which a sub-circuit VLC in a circuit area 3p is connected to another internal circuit CIR in addition to an external node N1, as a second example;

FIG. 41 shows an illustration depicting an exemplary state of external nodes in the case in which it is unnecessary to verify the current carried through a voltage source of a sub-circuit VLCv by simulation;

FIG. 42 shows an illustration depicting the state of external nodes in the case in which it is desired to verify the current carried through the voltage source of a sub-circuit VLCV by simulation in on-the-fly simulation for a circuit area 3p;

FIG. 43 shows an illustration depicting the case in which a sub-circuit VLC is deleted for on-the-fly simulation when no current is shown which is carried through all the devices in the sub-circuit VLC in on-the-fly simulation for a circuit area 3p;

FIG. 44 shows an illustration corresponding to FIG. 36 when a ground potential GND is not connected to a sub-circuit VLC;

FIG. 45 shows an illustration depicting the case in which a voltage source loop VLP is formed in FIG. 44;

FIG. 46 shows an illustration corresponding to FIG. 38 when a ground potential GND is not connected to a sub-circuit VLC;

FIG. 47 shows an illustration corresponding to FIG. 40 when a ground potential GND is not connected to a sub-circuit VLC;

FIG. 48 shows an illustration corresponding to FIG. 41 when a ground potential GND is not connected to a sub-circuit VLC; and

FIG. 49 shows an illustration corresponding to FIG. 42 when a ground potential GND is not connected to a sub-circuit VLC.

### DETAILED DESCRIPTION OF THE PREFERRED EMBODIMENTS

### On-the-Fly Simulation

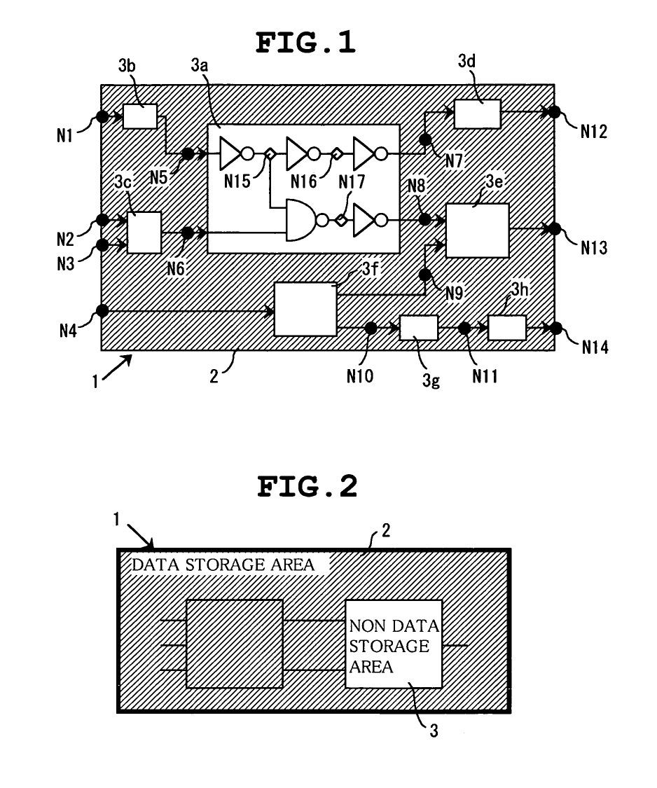

FIG. 1 shows the concept that is the premise of a simulation method according to the invention along with exemplary result output sections.

In the drawing, 1 denotes a simulation target circuit specified by design data. When circuit simulation is performed, input waveform information is given to a specified signal terminal or circuit node, and a non-linear equation and a circuit matrix are solved based on this initial information, whereby an initial circuit state is decided. At this time, the initial values of all the circuit nodes are decided. The input waveform information is transited based on the initial circuit state to solve the non-linear equation and the circuit matrix, whereby transition data of the circuit nodes are determined while the circuit state is decided. Among the items of data, the resulting data of the circuit node specified as the result output node is stored. The circuit node whose resulting data is stored is limited to circuit nodes in a higher level layer area in layered design data. In FIG. 1, circuit nodes N1 to N14 included in a hatched circuit area (data storage area) 2 are set as the result output nodes, and the resulting data thereof is stored. The transition data relating to circuit nodes in circuit areas (non data storage areas) 3a to 3h not hatched is not stored as the resulting data (nodes N15 to N17 in 3a in a typified case). In storing the resulting data, the initial values of all the circuit nodes of the simulation target circuit 1 are also stored in addition to the transition data of the circuit node specified as the result output node. The initial value relating to the circuit node in the data storage area may be included in transition data. For example, when simulation results relating to the circuit nodes N15 to N17 in the circuit area 3a are desired, the initial states of the internal circuit nodes N15 to N17 in the circuit area 3a are decided by the stored initial value, and the states of the circuit nodes N5 to N8 externally connected to the circuit area 3a are decided by the stored resulting data. Therefore, simulation for the sub-circuit area 3a can be executed under the initial condition equivalent to that of simulation done for the entire target circuit 1. Thus, resulting data obtained for the circuit nodes N15 to N17 in the area 3a may be shown. For the internal circuit nodes in the other circuit areas 3b to 3h, partial simulation may be again executed as necessary, and the results may be shown. Simulation for such a non data storage area is also referred to as on-the-fly simulation in a sense that such simulation is performed that restores information to be shown on the spot when it is desired to show the results.

FIG. 2 shows the concept of the simulation method according to the invention further in principles. A non data storage area is collectively denoted as 3. The parameter that separates a data storage area 2 from the non data storage area 3 depends on the layer structure of layered circuit data.

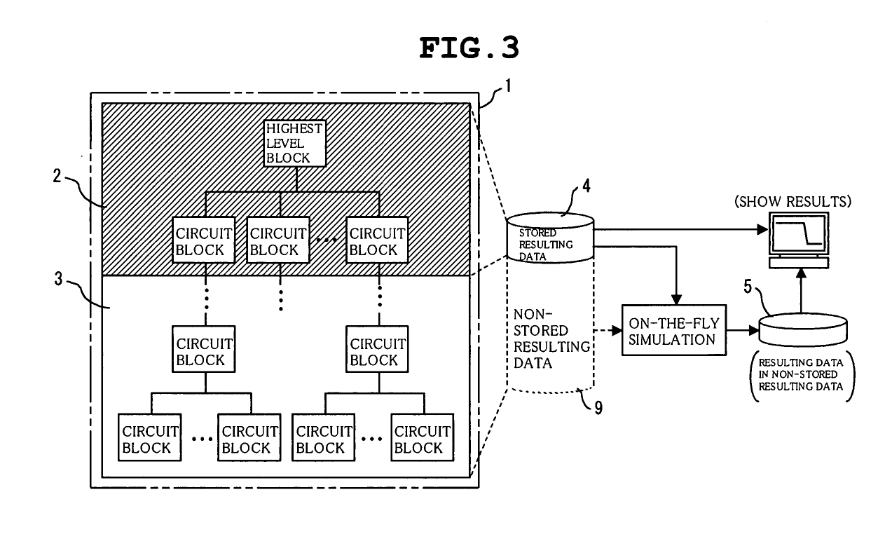

FIG. 3 shows the principle of the simulation method according to the invention, focusing attention on the layer structure of layered circuit data. The simulation target circuit 1 is defined by layered circuit blocks. The circuit blocks are layered from the circuit blocks at the highest level to the circuit blocks at the undermost layer. The data storage area 2 is defined as a circuit at the higher level layers specified by layer data from blocks at the highest level layer to circuit blocks at a given layer for each path in the layer structure. The non data storage area 3 is defined as a circuit specified by circuit blocks at the lower level layers than the layers defining the data storage area 2. The circuit nodes in the data storage area 2 are set to result output nodes, and the resulting data of the nodes is stored as stored resulting data 4. For the request to show the circuit nodes in the non data storage area 3 which are not stored in simulation, resulting data 5 may be shown which is obtained by the on-the-fly simulation.

As apparent from FIG. 3, when the simulation results of the circuit nodes in the non data storage area 3 at the lower level layer are also stored as the result output nodes, it is also necessary that non-stored resulting data 9 is made to be a target for storage as the data to be stored. Therefore, when the simulation method is adopted which shows the resulting data 5 obtained by the on-the-fly simulation for the circuit nodes in the non data storage area 3 at every time when required, a small storage capacity can achieve the data showing performance equivalent to the case of storing all the items of simulation resulting data of a large-scale simulation target such as a large-scale integrated circuit. A reduction in the resulting data volume to be stored allows a shortened retrieval time for resulting data.

Next, a scheme will be described which obtains a simulation result having a change reflected when a partial change in a circuit or a change in device parameters is made in the simulation target circuit 1 after the stored resulting data 4 is obtained.

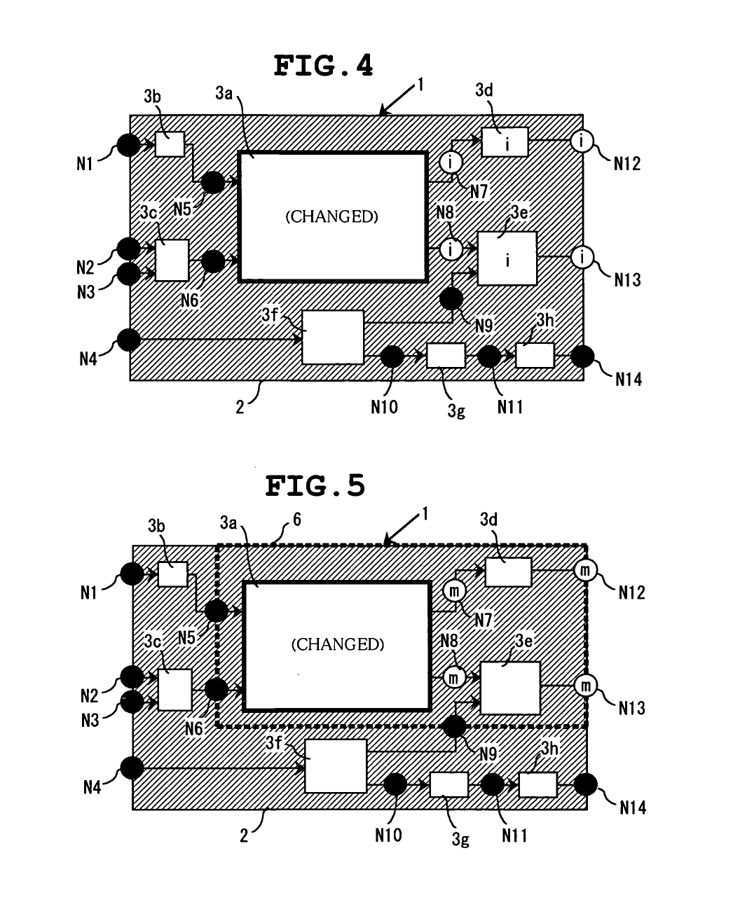

FIG. 4 shows an exemplary state when a partial change in a circuit or a change in device parameters is made in the simulation target circuit. In FIG. 4, for example, the circuit area 3a is changed. It is supposed that before this change, the resulting data of the circuit nodes N1 to N14 in the data storage area 2 is already stored by simulation for the simulation target circuit. The change in the circuit area 3a affects the circuit nodes N7, N8, N12 and N13 and the internal circuit nodes in circuit areas 3d and 3e that receive the output of the circuit area 3a from the upstream of the signal transmission. Character i is designated to the circuit nodes and the circuit areas affected in FIG. 4.

FIG. 5 shows an exemplary scheme which obtains a simulation result having reflected a change when a partial change in a circuit or a change in device parameters is made. The change in the circuit area 3a when the stored resulting data 4 is obtained affects the circuit node N7, N8, N12 and N13 and the circuit nodes inside the circuit areas 3d and 3e that receive the output of the circuit area 3a from the upstream of the signal transmission. Simulation is performed by the scheme similar to the on-the-fly simulation for a circuit area 6 which receives such a change and the influence caused by the change. The states of the circuit nodes not affected by the change, that is, the circuit nodes N5, N6 and N9 externally connected to the circuit area 6 are decided by the stored resulting data. For the circuit nodes inside the changed circuit area 3a, the initial values are decided in accordance with the changed descriptions. In addition, for the circuit nodes N7, N8, N12 and N13 and the circuit nodes inside the circuit areas 3d and 3e that receive the output of the circuit area 3a from the upstream of the signal transmission, the initial values are decided in accordance with the change in the circuit area 3a as well. Thus, simulation for the sub-circuit area 6 can be performed under the initial condition equivalent to that of simulation conducted for the entire target circuit 1 partially changed, and the resulting data thus obtained for the circuit nodes N7, N8, N12 and N13 in the circuit area 6 may be replaced by the resulting data of the circuit nodes before changed. In FIG. 5, the circuit nodes N7, N8, N12 and N13 which are the result output nodes to obtain changed resulting data has Character m.

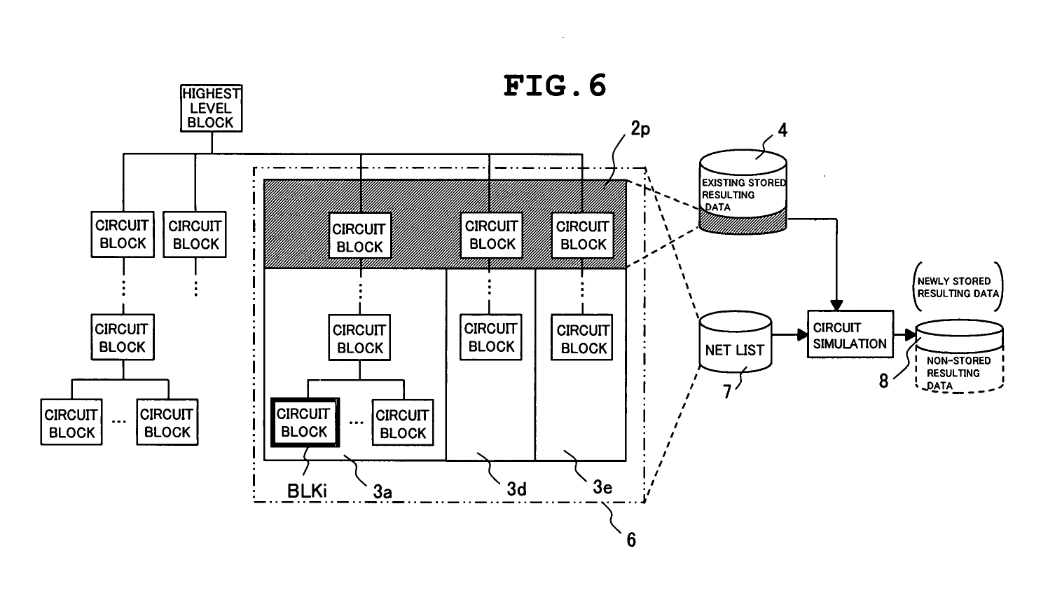

FIG. 6 shows the principle of the simulation method which copes with the partial change shown in FIG. 5, focusing attention on the layer structure of layered circuit data. A circuit block BLKi shown in FIG. 6 depicts a circuit block which has the partial change in the circuit or the change in device parameters in the circuit area 6. 2p shown in FIG. 6 means the data storage area in the circuit are 6 shown in FIG. 5. The areas 3a, 3d and 3e which are non data storage areas have the data of the circuit blocks at the lower layer. A part of the stored resulting data 4 is used to conduct circuit simulation for a net list 7 in the circuit area 6, whereby new stored resulting data 8 relating to the circuit area 6 is created.

As described above, simulation can be performed by the scheme similar to the on-the-fly simulation for the circuit area 6 which receives the influence of the change such as a partial change in a circuit. Therefore, the scale of the target circuit in simulation can be reduced, and the resimulation time can be shortened when a partial change in a circuit or a change in device parameters is made in a large-scale circuit.

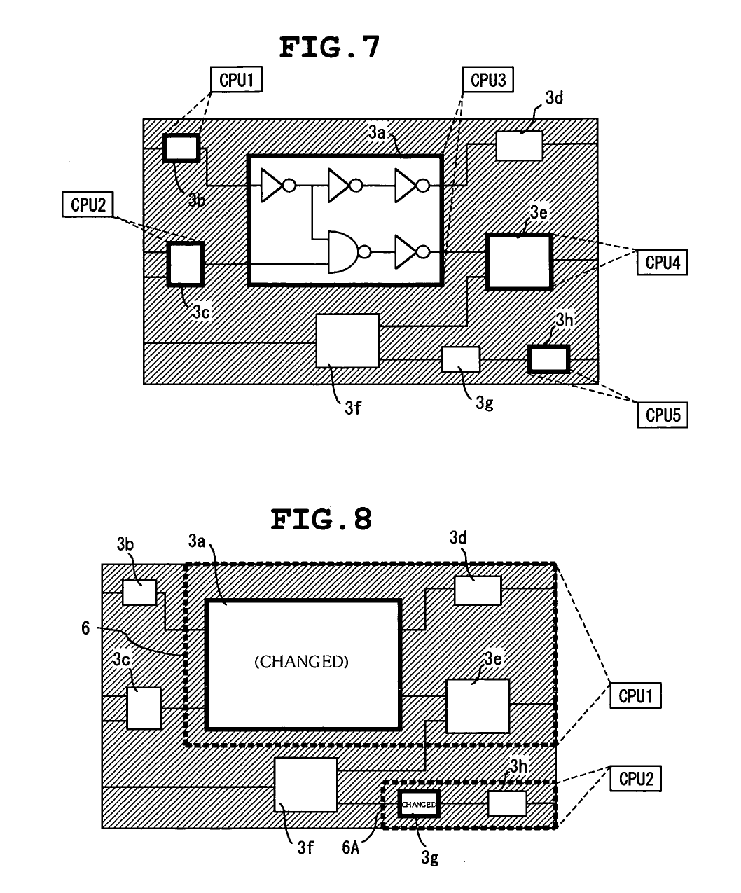

FIG. 7 shows exemplary parallel processing of the on-the-fly simulation. When on-the-fly simulation explained in FIG. 1 is conducted in a plurality of circuit areas, a plurality of processors CPUL to CPU5 may be used to do a parallel arithmetic process. Thus, the computing process and the showing operation in response to a showing instruction for a plurality of the circuit areas can be accelerated.

FIG. 8 shows exemplary parallel processing for simulation similar to on-the-fly simulation conducted for the sub-area caused by a change such as a change in a circuit. When sub-areas 6 and 6A in the drawing have multiple places that are affected by a partial change in a circuit, the parallel arithmetic process may be conducted for the sub-areas 6 and 6A by using a plurality of the processors CPU1 and CPU2. Therefore, even when a plurality of places having a change in a circuit extends to a plurality of the sub-areas 6 and 6A which do share no signal path, the resimulation process for those areas can be accelerated.

Next, the simulation method explained in FIG. 1 will be described more detailedly.

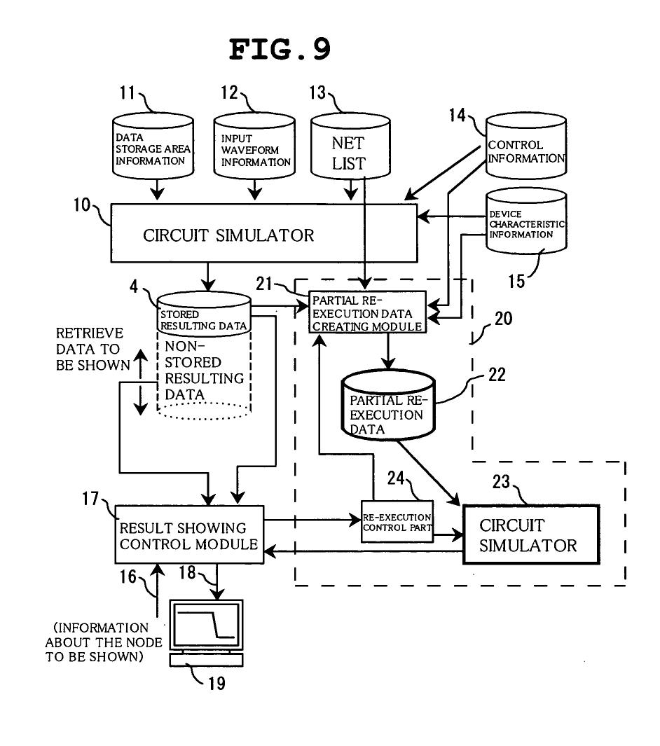

FIG. 9 shows an exemplary data processing system which implements the simulation method according to the invention. A net list 13 is layered circuit data which identifies a simulation target circuit. Data storage area information 11 is information which decides the circuit node to be extracted as a result output node in layered circuit data, for example, and information which specifies a desired layer level of layered circuit data. The layer level specified is referred to as a specified layer level. Input waveform information 12 is information which defines a signal waveform given to a signal terminal or a circuit node specified by the layered circuit data, and the initial value of the circuit node in the simulation target circuit is decided by the input waveform information 12, etc. Device characteristic information 15 means device model parameters which define the circuit characteristic of a circuit device specified by the layered circuit data. Control information 14 means other items of control information which control the operation of a circuit simulator 10 which conducts simulation. The circuit simulator 10 accepts the data storage area information 11, the input waveform information 12, the net list 13, the control information 14, and the device characteristic information 15, it conducts circuit simulation in which the circuit nodes at the higher level layer specified by the layered circuit data are the result output nodes as shown in FIG. 1, and it stores the results as stored resulting data 4.

When specification information 16 about the node to be shown is inputted, a result showing control module 17 for the simulation result searches whether the circuit node specified by the information is included in the stored resulting data 4. When it is included, it controls showing the data of the searched circuit node as result waveform information 18 on a display 19.

When the stored resulting data 4 does not include the data of the circuit node that is specified by the specification information 16 about the node to be shown, the result showing control module 17 shows waveform information about the required circuit node on the display 19 through on-the-fly simulation. This process is controlled by a sub-circuit simulation control module 20 which controls on-the-fly simulation. More specifically, when the data of a required circuit node is not included in the stored resulting data 4, a re-execution control part 24 references to the net list 13, the control information 14, the device characteristic information 15 and the stored resulting data 4, and creates information required for circuit simulation in which the circuit node is the result output node at a partial re-execution datacreatingmodule21. For example, partial re-execution data 22 created is data into which information about the nodes N5 to N8 stored for partially simulating the circuit area 3a shown in FIG. 1, initial value information about the internal circuit nodes N15 to N17 in the circuit area 3a, logical construction information, and characteristic information about devices forming logic are transformed to a format processable by the simulator. A circuit simulator 23 uses the partial re-execution data 22 to conduct simulation, and creates the waveform data of the required result output node. The created waveform data is shown on the display 19 through the result showing control module 17. Not shown in the drawing particularly, a conventional simulation process system sets circuit nodes in the entire target circuit to the result output nodes to conduct simulation, and obtains data in the volume of the stored resulting data 4 shown in FIG. 9 and the non-stored resulting data with no distinction. In the conventional simulation process system, there is no module which controls sub-circuit simulation done by on-the-fly simulation control as shown in FIG. 9. It sends only an error response in response to a showing instruction when there is no waveform information about the circuit node specified by that instruction.

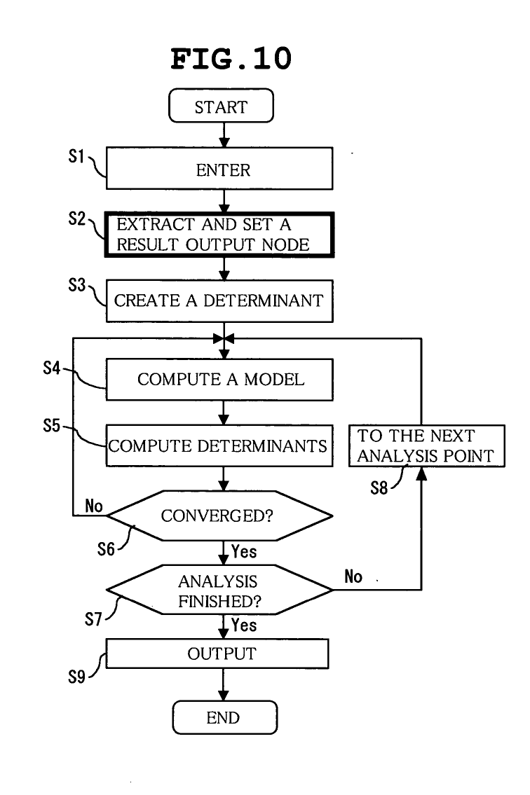

FIG. 10 shows an exemplary circuit simulation process flow done by the circuit simulator 10 shown in FIG. 9. Required information such as the net list 13 is inputted (S1) . Based on the input information, the circuit node at the specified layer is extracted from the circuit nodes of the simulation target, and is set as a result output node (S2). A determinant for simulation is created based on the input information (S3). After device model computation (S4) and determinant computation (S5), it is determined whether a convergence of solutions according to the Newton-Raphson method is obtained (S6) . The process steps are repeated until a convergence is obtained within a predetermined error range. The convergence value thus obtained is considered to be one value of the transition state in the result output node at that time, and the model computation, the determinant computation, and the convergence determination are repeated until analysis of all the result output nodes is finished (S7 and S8). The resulting data obtained for each of the result output nodes at the process steps is outputted (S9) and stored.

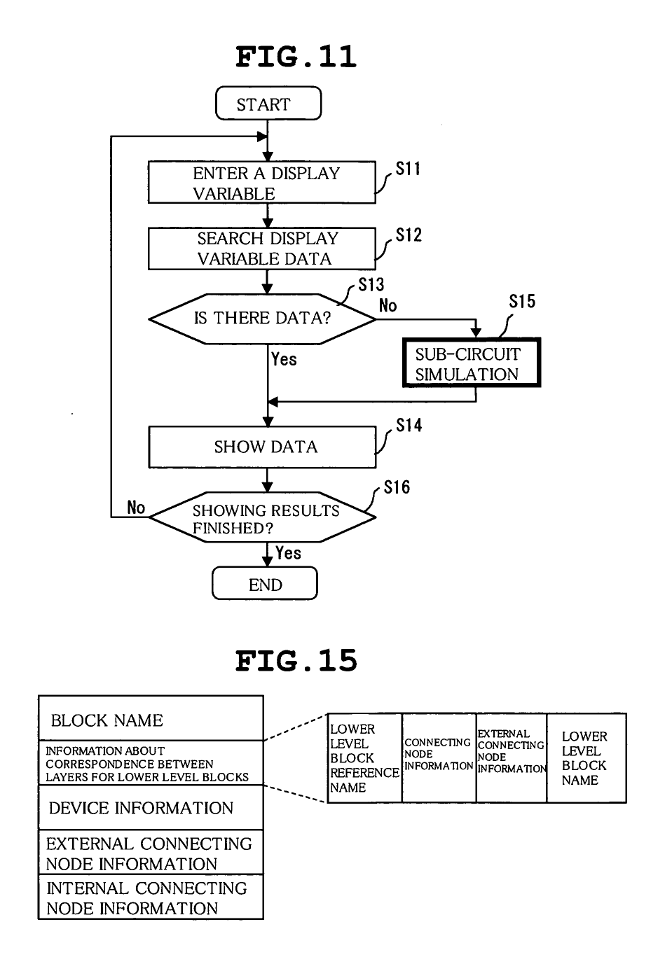

FIG. 11 shows an exemplary flow of result showing control over the simulation results done by the result showing control module 17 and the sub-circuit simulation control module 20 shown in FIG. 9. When a display variable is given which indicates the circuit node specified by the specification information 16 about the node to be shown (S11), the data of the display variable is searched (S12), and it is determined whether there is the corresponding resulting data (S13) . When there is the corresponding resulting data, the data is shown (S14). When there is not the corresponding resulting data, a sub-circuit simulation process is conducted by the sub-circuit simulation control module 20 (S15), and the resulting data thus obtained is displayed (S14). The process steps are repeated to control showing results until an instruction that finishes showing results is made (S16).

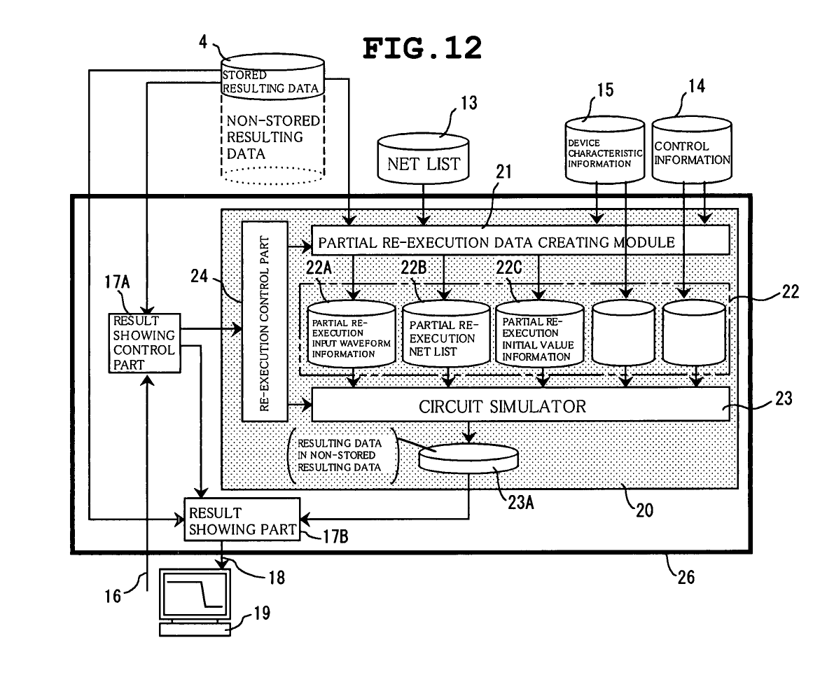

FIG. 12 shows an exemplary result showing control module 26 with an on-the-fly simulation function configured of the sub-circuit simulation control module 20 and the result showing control module 17 shown in FIG. 9 in detail. Partial re-execution data 22 created at the partial re-execution data creating module 21 includes partial re-execution input waveform information 22A, a partial re-execution net list 22B, and partial re-execution initial value information 22C. It is supposed that the simulation target for re-execution by on-the-fly simulation is the circuit area 3a shown in FIG. 1. For example, the partial re-execution input waveform information 22A is information about the circuit nodes N5 to N8 shown in FIG. 1 included in the stored resulting data. For example, the partial re-execution net list 22B is the net list which defines the circuit configuration of the circuit area 3a shown in FIG. 1. For example, the partial re-execution initial value information 22C is initial value information about the internal circuit nodes N15 to N17 in the circuit area 3a, the information being stored along with the stored resulting data 4. With circuit simulation using the partial re-execution data, information about the required circuit node in the circuit nodes is obtained as resulting data 23A, the information being non-stored resulting data.

Next, a process will be described which extracts a circuit node in a higher level circuit area as a result output node. The process corresponds to the result output node extracting process at Step S2 shown in FIG. 10.

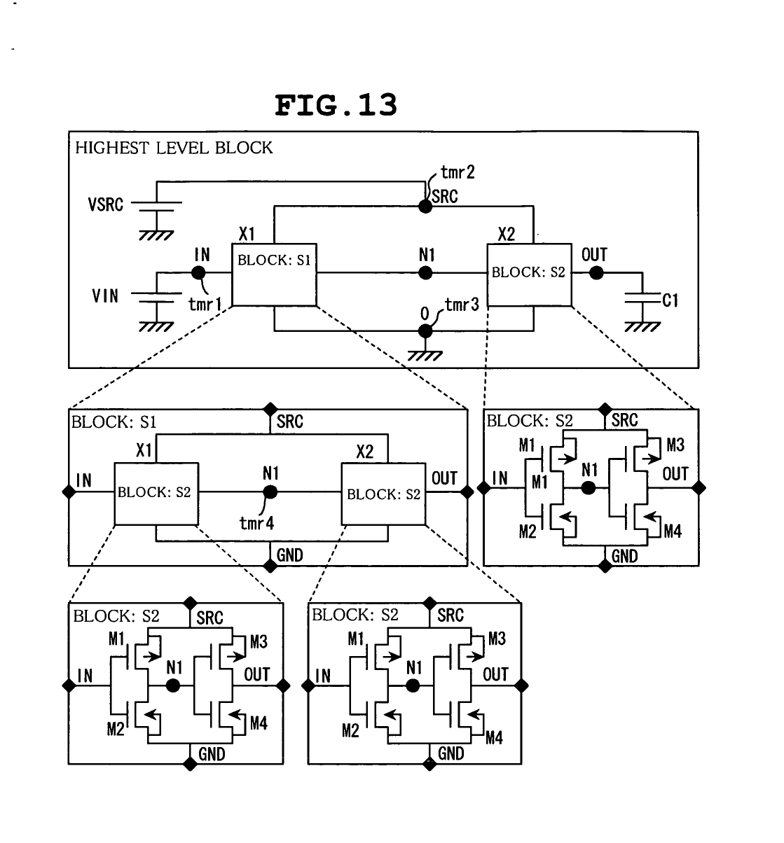

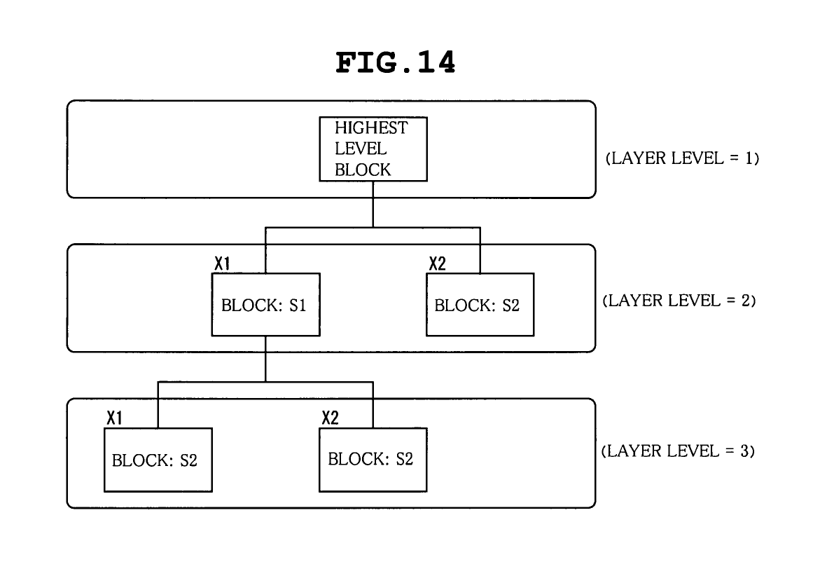

FIG. 13 shows an exemplary layer structure according to circuit data (layered circuit data) having a layer structure. A black circle means an internal connecting node among circuit nodes in a circuit block (hereinafter, also simply denoted as a block). A black rhombus means an external connecting node among circuit nodes in a block. FIG. 14 shows the relationship between the layer structure of the circuit block shown in FIG. 13 and the layer level. From FIGS. 13 and 14, the highest level block references to lower level blocks S1 and S2, and a block S1 at the layer level 2 references to a block S2. A block S2 at the layer level 3 does not reference to the lower level block.

FIG. 15 shows exemplary information held by the circuit blocks at each layer in the layered circuit data explained in FIG. 3. The circuit block has a block name, information about correspondence between layers for lower level blocks, device information, external connecting node information, and internal connecting node information. Information about correspondence between layers for lower level blocks and device information are sometimes unnecessary. The information about correspondence between layers for lower level blocks has a lower level block reference name, connecting node information, external connecting node information, and a lower level block name. When the highest level block shown in FIG. 13 is taken as an example, the lower level block reference name is X1 and X2 on the defining side that defines references, and the lower level block names are S1 on the defined side that is referenced in association with X1 and S2 on the referenced side in association with X2.

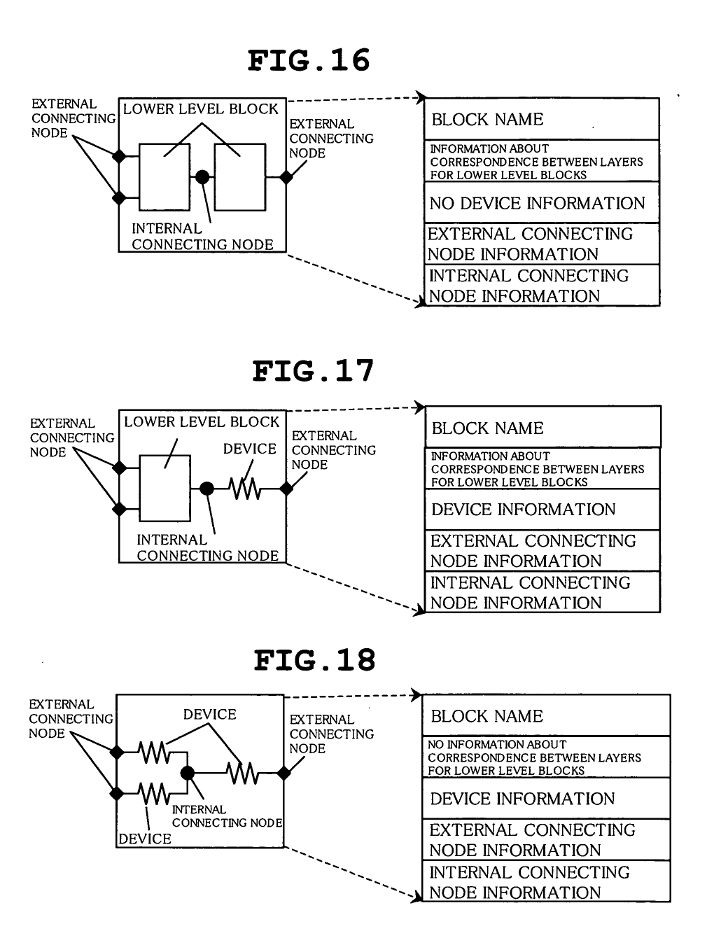

The form of the circuit block will be described. The form of the circuit block is roughly categorized into the form configured only of the lower level blocks exemplified in FIG. 16, the form configured of a lower level block and a device exemplified in FIG. 17, and the form configured only of devices exemplified in FIG. 18. The device means a circuit element of the lowest level concept, meaning mathematical elements expressed by a transistor, resistance, capacitance, a transfer function, etc. The block is positioned as a set of a plurality of circuit devices. Circuit information about the circuit block shown in FIG. 16 does not have device information. The circuit block shown in FIG. 18 does not have the information about correspondence between layers for lower level blocks.

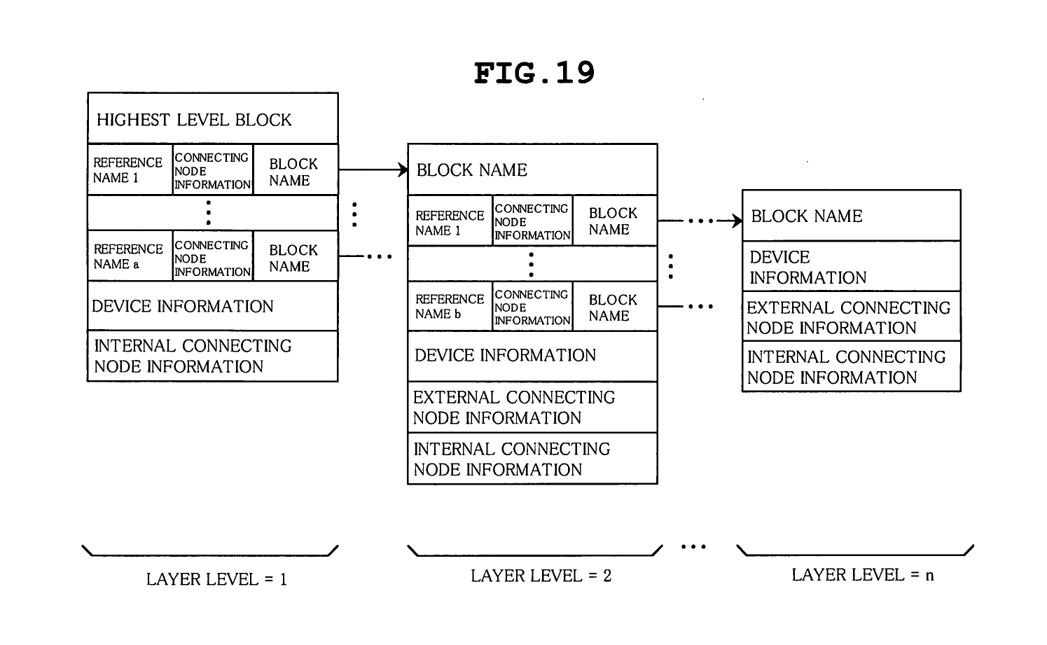

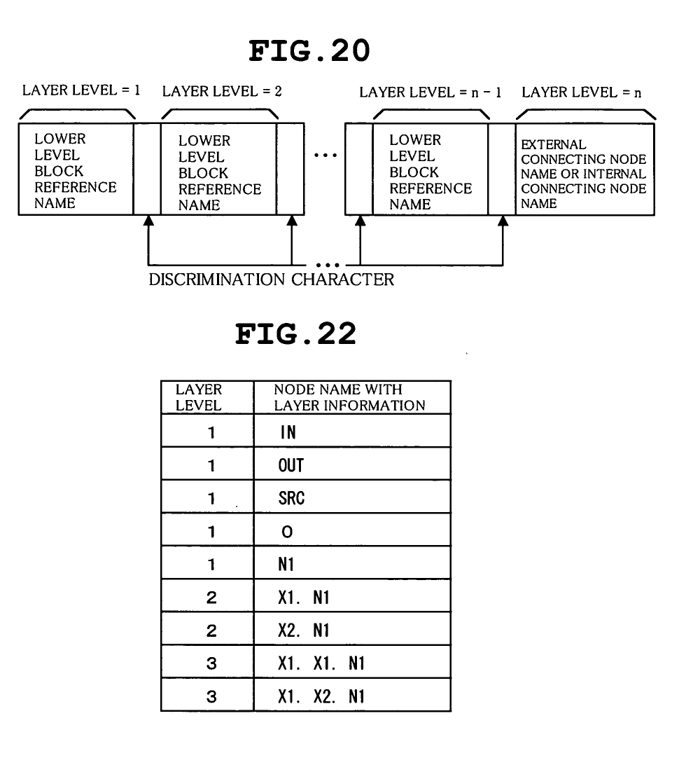

FIG. 19 shows an exemplary general data form of the layered items of circuit block information about the entire simulation target circuit and the layer levels. The linkage of circuit block information between the layer levels is conducted by the information about correspondence between layers for lower level blocks. The information format is not limited particularly when node information about the external connecting node or the internal connecting node is extracted from circuit block information in the data form exemplified in FIG. 19. However, as shown in FIG. 20, the lower level block reference name is marked and added with a delimiter from the highest level for each layer level, and an information format is formed as a node name with layer information which has an external connecting node name or an internal connecting node name at the tail.

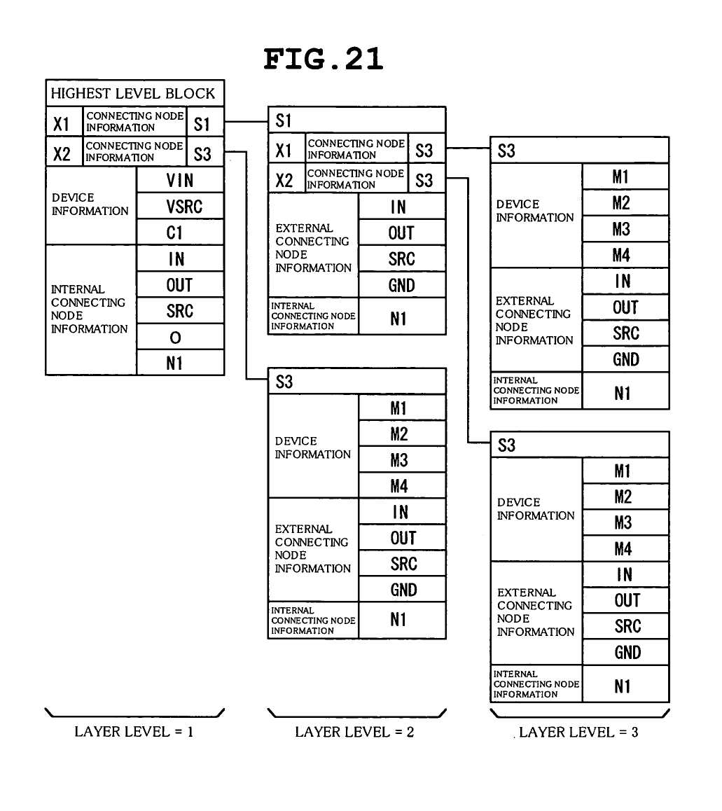

FIG. 21 shows a specific example of the layered items of circuit block information about the entire simulation target circuit having the layer structure and the layer levels exemplified in FIG. 13. FIG. 22 shows all the items of node information about the external connecting node and the internal connecting node extracted from the circuit block information shown in FIG. 21 as node names with layer information.

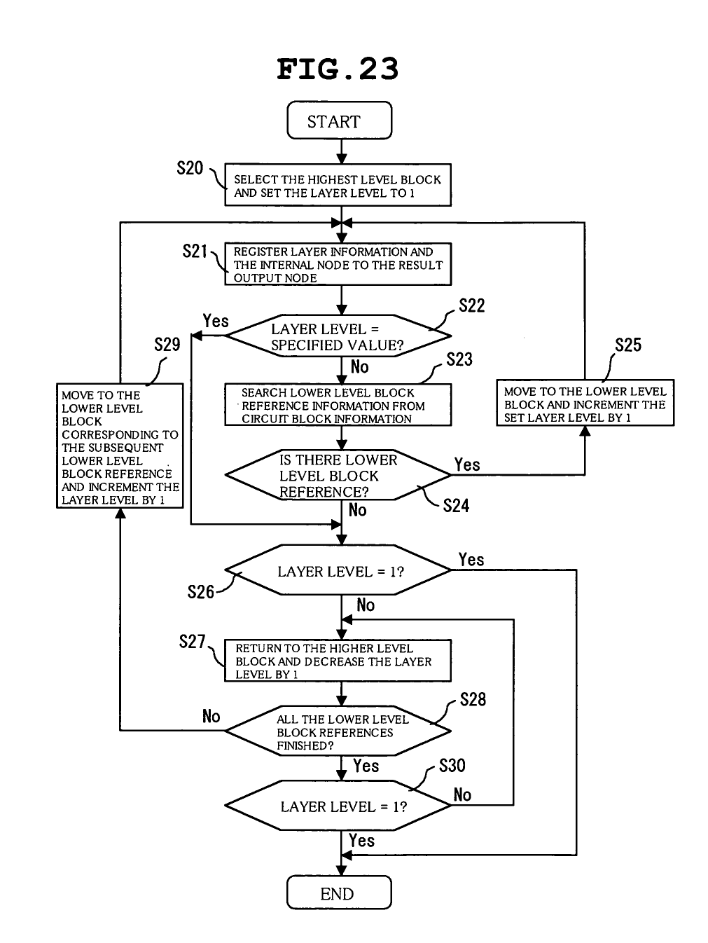

FIG. 23 shows an exemplary control flow chart depicting the result output node extracting process. First, the highest level block is selected, and the layer level is set to 1 (S20). The layer information about the set layer level and an internal node are registered to the result output node as a node name with layer information (S21). Subsequently, it is determined whether the specified value of the layer level specified as the data storage area information 11 shown in FIG. 9 (specified layer level) is equal to the set value at Step S20 (the set layer level) (S22). When they are not matched, lower level block reference information is searched from circuit block information (S23), and it is determined whether there is a lower level block reference (S24) . When there is a lower level block reference, the process is moved to the lower level block of that reference, and the set layer level is incremented by 1 (S25) . The process steps at Steps S21 to S24 are performed in the moved lower level block. The process steps are repeated until the set layer level reaches the specified layer level, or until references of the lower level block are gone.

When references of the lower level block are gone, or the set layer level reaches the specified layer level, it is determined whether the set layer level is 1 (S26) when the level is not 1, the process is returned to the block one level above the set layer level, and the set layer level is decreased by 1 (S27). It is determined whether all the lower level block references are finished in the block at the set layer level (S28). More specifically, it is determined whether there is another lower level block reference that is linked to the lower level therefrom. AS the result of determination, when there is another lower level block reference, the process is moved to the lower level block corresponding to the subsequent lower level block reference, and the set layer level is incremented by 1 (S29). The process is returned to Step S21, and the same process steps are repeated. When it is determined that there is not another lower level block reference that is linked to the lower level from the set layer level by the determination at Step S28, it is determined whether the set layer level is 1 (S30). When the level is not 1, the process is returned to Step S27, and the process steps are repeated until it is determined that the set layer level is 1 at Step S26 or S30.

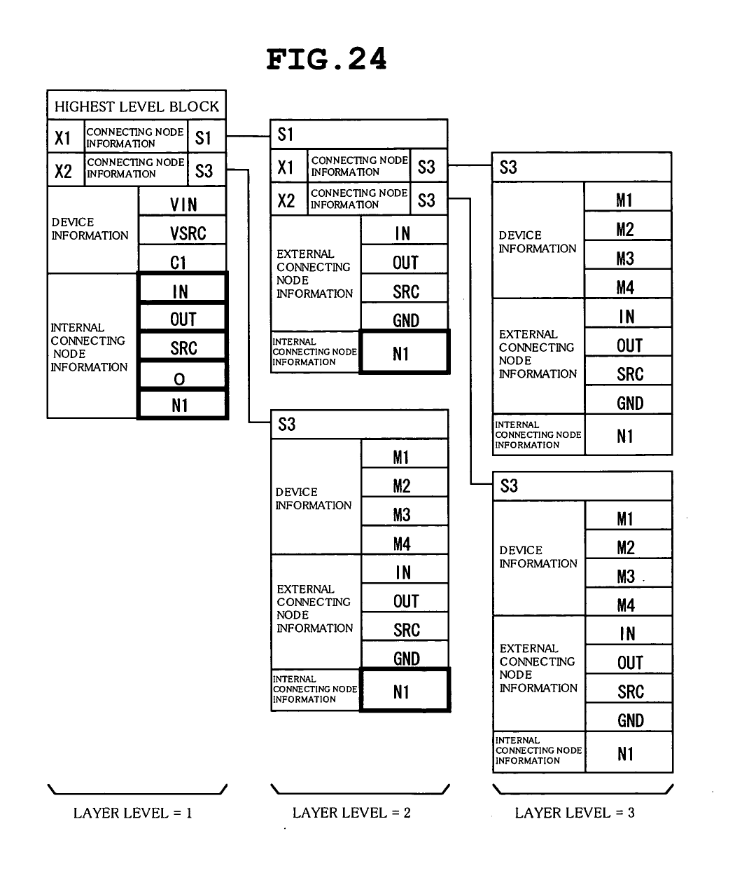

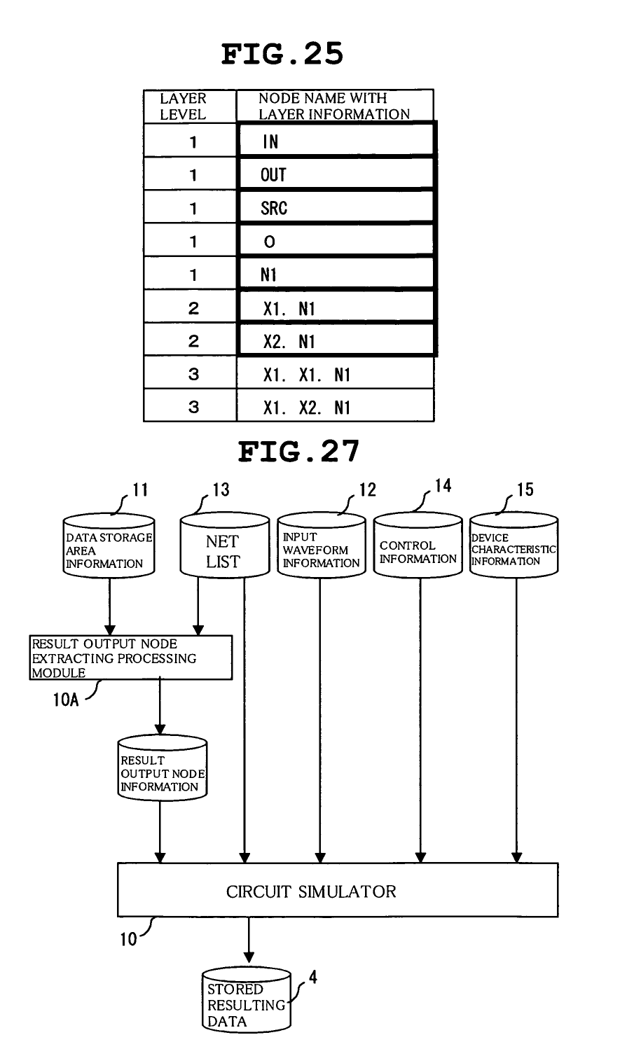

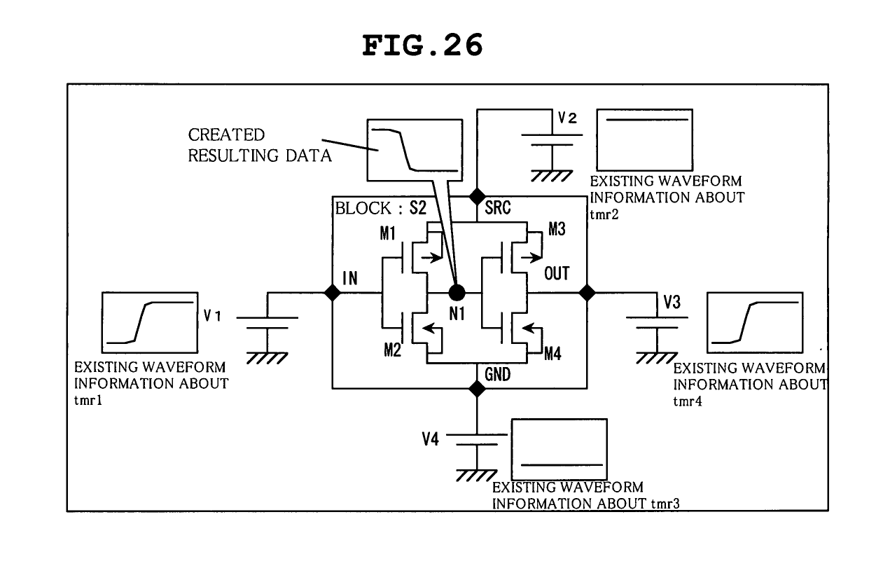

FIG. 24 shows exemplary locations of node information extracted when the extracting process shown in FIG. 23 is conducted for the layered items of circuit block information shown in FIG. 21 where the specified layer level is 2. The node information to be extracted is encircled by a thick rectangular frame. FIG. 25 shows the node names with layer information thus extracted and registered are encircled by a thick rectangular frame. The extracted circuit nodes are considered to be the output nodes of the simulation result done by the circuit simulator 10 shown in FIG. 9. The circuit nodes at the layer level 3 shown in FIG. 25 are considered to be given result output nodes by on-the-fly simulation. The explanation is made in accordance with this example, a node name N1 at the layer level 3 shown in FIG. 25, that is, the simulation waveform of the circuit node N1 of the circuit blocks X1 and X2 that are referenced in the circuit block X1 which is referenced in the highest level block shown in FIG. 13 is computed by the on-the-fly simulation, and is allowed to be shown. FIG. 26 shows an exemplary conceptual diagram depicting the case in which the simulation result is created for nodes X1, X1 and N1 with layer information in the circuit shown in FIG. 13 by on-the-fly simulation tmr1, tmr2, tmr3 and tmr4 mean the corresponding nodes shown in FIG. 13.

In the explanation above, the function of the extracting process for the result output node is considered to be included in the function of the circuit simulator 10 shown in FIG. 9 as a part thereof. As exemplified in FIG. 27, a result output node extracting processing module 10A may be isolated from the circuit simulator 10. In short, a result output node extracting program may be used which is offered separately from the circuit simulator. In FIG. 27, a module for on-the-fly simulation is omitted in the drawing.

Lower Layer Dependence of the Resulting Data

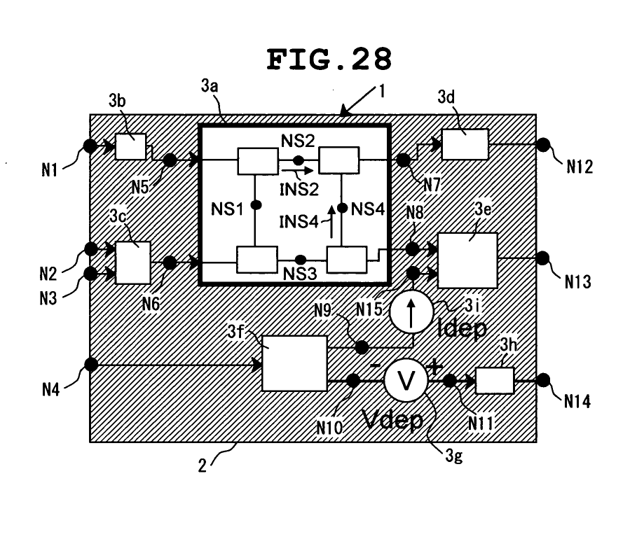

As described with reference to FIG. 1, in the simulation method, the circuit node that the resulting data by circuit simulation is stored is limited to the circuit node in the higher level layer area in the layered design data, but the invention is not limited thereto. In other words, as exemplified in FIG. 28, when a current source 3i and a voltage source 3g in a circuit area 2 which is a data storage area at the higher layer depend on the value of the internal node or on the state of the internal device in a circuit area 3a which is a non data storage area at the lower layer, the value of the internal node and information about the internal device in the circuit area 3a are also stored together. In the example shown in FIG. 28, a current value Idep of the current source 3i depends on the voltage VNS3 of an internal node NS3 and a current value INS4 carried through a node NS4. A voltage Vdep of the voltage source 3g is considered to be the voltage difference between a node N121 and a node N10, and this depends on a voltage VNS1 of an internal node NS1 and a current INS2 carried through an internal node NS2.

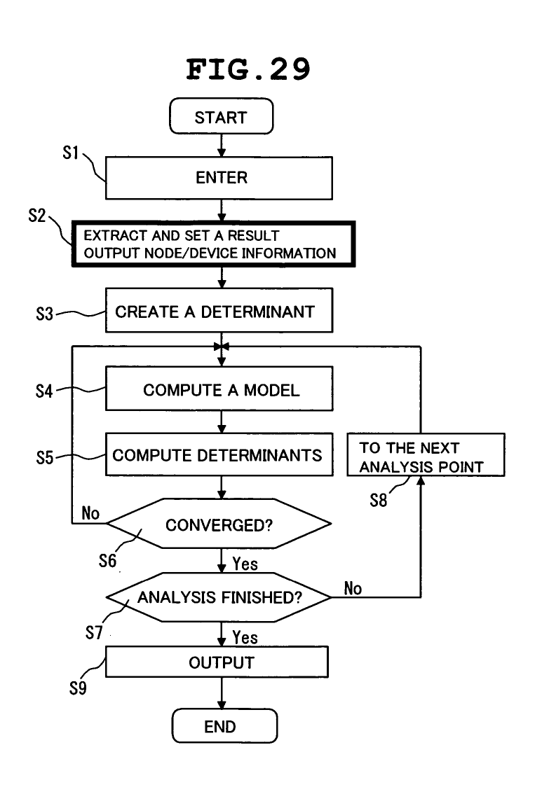

FIG. 29 shows a process flow depicting circuit simulation for the case shown in FIG. 28. The different from FIG. 10 is a process at Step S2. In FIG. 29, for the target to be extracted as a result output node, the internal node at the higher layer is extracted as well as the internal node at the lower layer having a dependent relationship is extracted, and device information at the lower layer having a dependent relationship is extracted as well.

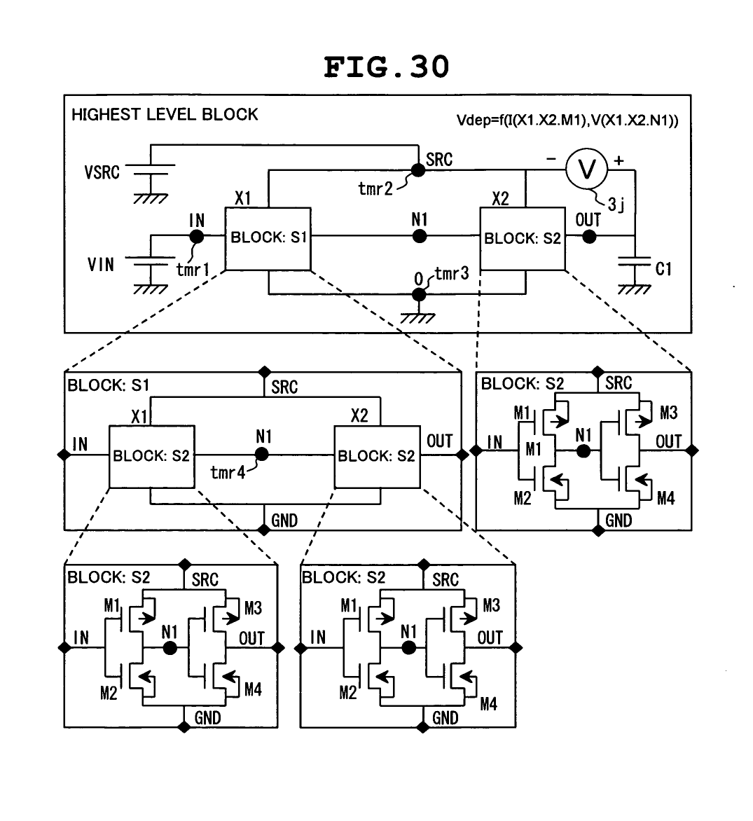

FIG. 30 shows an exemplary layer structure of layered circuit data in the case in which the resulting data has lower layer dependence. The difference from FIG. 13 is in that it shows the case in which a voltage source 3j in the highest level block depends on the state of internal nodes and circuit devices in blocks X1 and X2 at the lower layer. A voltage Vdep of the voltage source 3j depends on a current I (X1, X2, M1) carried through a device M1 in blocks X1 and X2 and a voltage V (X1, X2, N1) of a node N1 in the blocks X1 and X2. In other words, the current I (X1, X2, M1) depends on the current carried through the device M1 in the block X2 and the current carried through the device Ml in the block X1. The voltage V (X1, X2, N1) depends on the voltage of the node N1 in the block X2 and the voltage of the node N1 in the block X1.

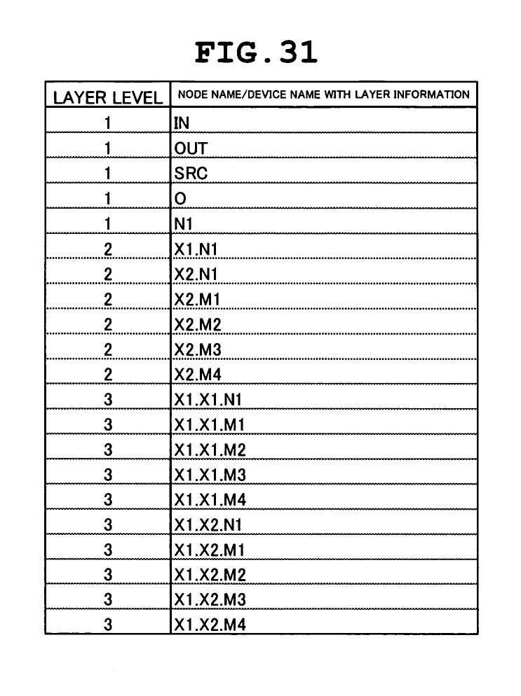

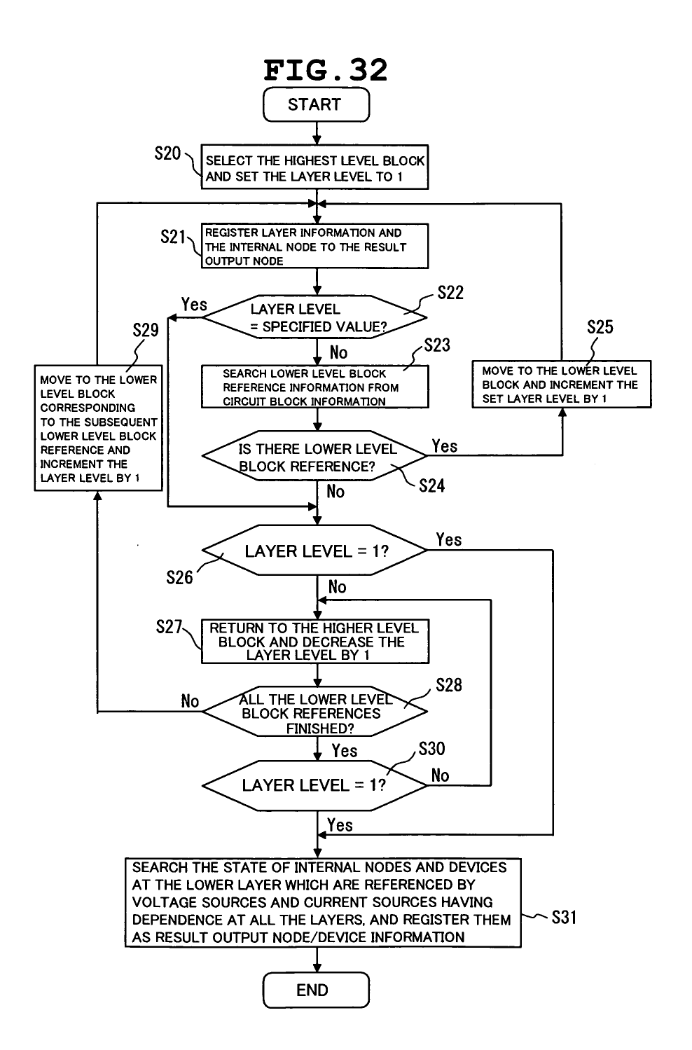

The specific example of the layered items of circuit block information about the entire simulation target circuit having the layer structure and the layer level shown in FIG. 30 is basically the same as that shown in FIG. 21. FIG. 31 shows an exemplary state in which all the items of node information about the external connecting node and the internal connecting node extracted from the circuit block information shown in FIG. 21 are given as node names with layer information in the case shown in FIG. 30. FIG. 32 shows an exemplary control flow chart depicting the result output node extracting process in the case shown in FIG. 30. The difference from FIG. 23 is in that Step S31 is added. In other words, at Step S31, the state is searched in which internal nodes and devices of the lower layer level referenced by voltage sources and current sources having dependence at all the layer levels, the searched node is added to the result output node, and the searched state of the device is registered as device information.

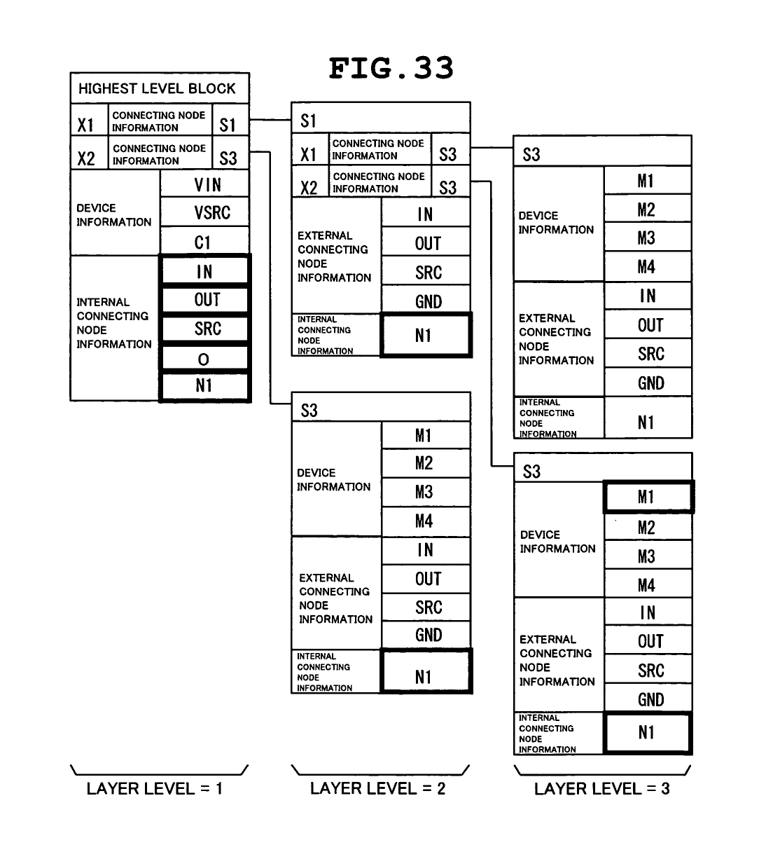

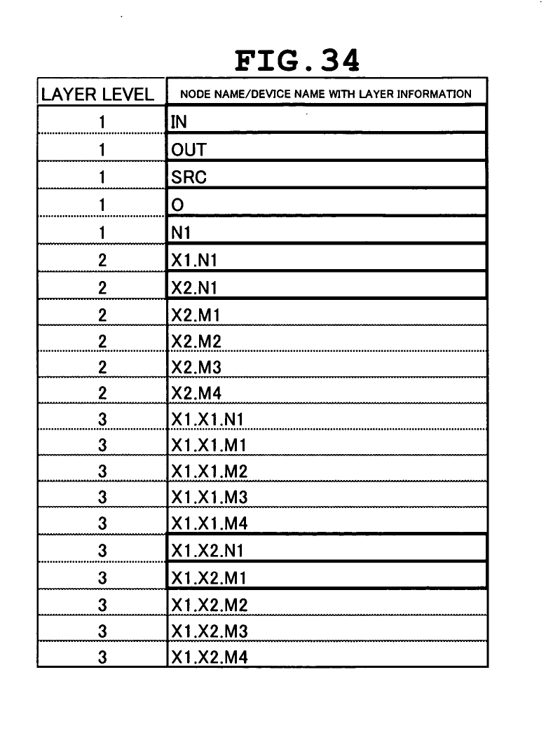

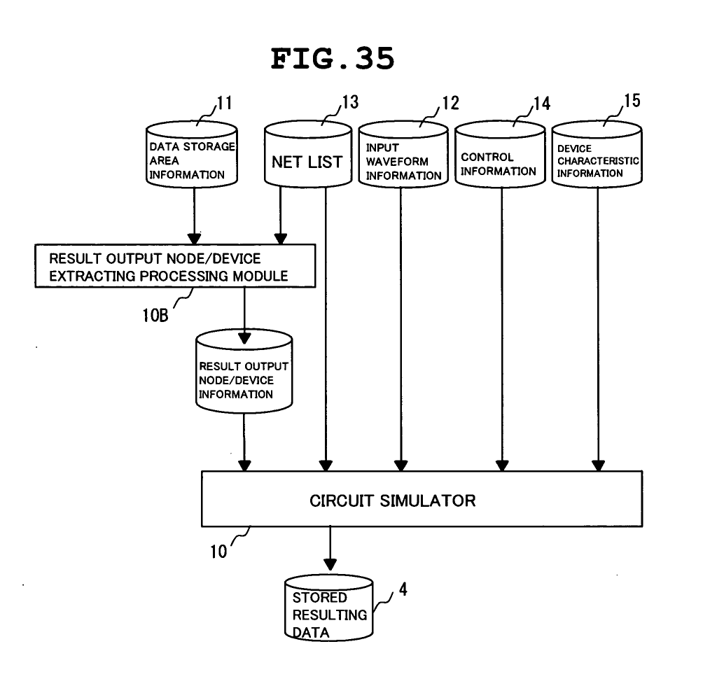

FIG. 33 shows exemplary locations of node information extracted when the extracting process shown in FIG. 32 is performed for the layered items of circuit block information about the entire simulation target circuit having the layer structure shown in FIG. 30, basically the same as that in FIG. 21, where the specified layer level is 2. The node information to be extracted is encircled by a thick rectangular frame. FIG. 34 shows node names with layer information thus extracted and registered as encircled by a thick rectangular frame. The difference from FIGS. 24 and 25 is in that device information and node information at the layer level 3 are extracted on which a voltage source 3j depends. The extracted circuit node is considered to be the output node of the simulation result done by the circuit simulator 10 shown in FIG. 9. The circuit nodes other than those encircled by thick rectangular frames at the layer level 3 shown in FIG. 34 are considered to be given result output nodes by on-the-fly simulation. In the explanation above, the function of the extracting process for the result output node is considered to be included in the function of the circuit simulator 10 shown in FIG. 9 as a part thereof. As exemplified in FIG. 35, a result output node and device extracting processing module 10B may be isolated from the circuit simulator 10. In short, a result output node and device extracting program may be used which is offered separately from the circuit simulator. In FIG. 35, a module for on-the-fly simulation is omitted in the drawing.

Suppression of the Voltage Source Loop

Next, a scheme to suppress the generation of a voltage source loop in the on-the-fly simulation in advance will be described.

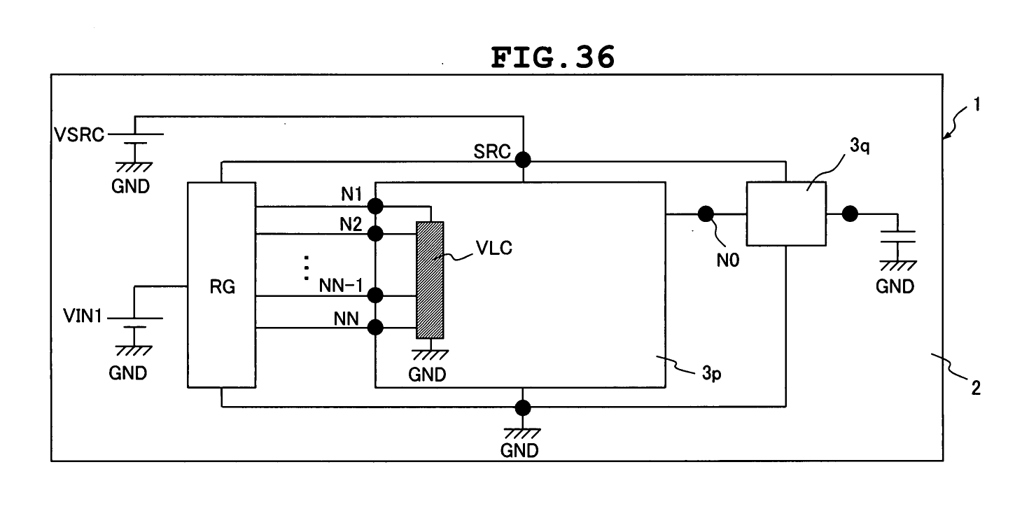

FIG. 36 shows a first example that attention is focused as the form likely to generate a voltage source loop. For a simulation target circuit 3p and 3q are circuit areas as the non data storage area. The circuit area 3p has a sub-circuit VLC configured of any one device of a voltage source and an inductor or configured of at least two of devices having a voltage source and an inductor joined to each other, and has one or more of external nodes N1 to NN which connect the sub-circuit VLC to the outside thereof. The sub-circuit is connected to a ground potential GND. It is revealed from the device information, the external connecting node information and the internal connecting node information described in FIGS. 15 to 18 that the circuit area 3p has these devices and nodes. RG is a resistor circuit, and VIN1 and VSRC are an external power source. SRC is a power source terminal to which the external power source VSRC is supplied.

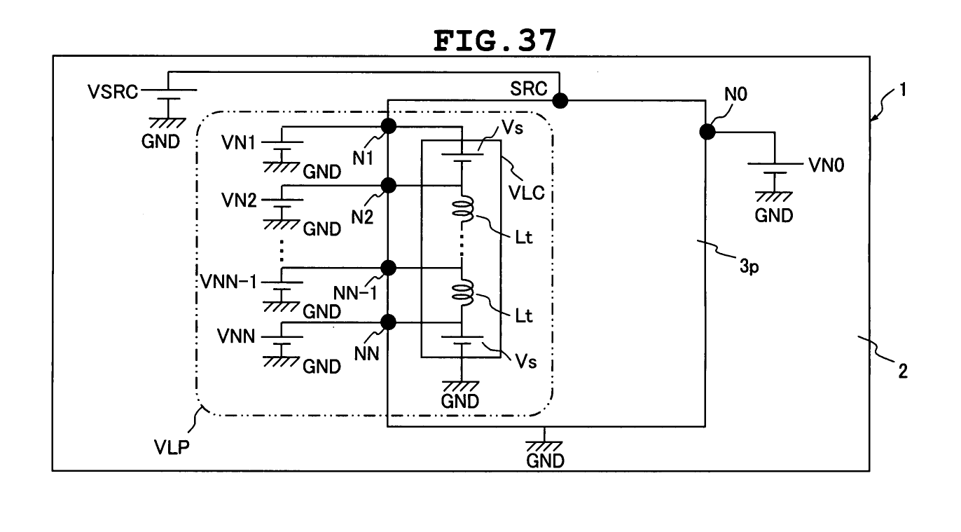

FIG. 37 shows an example in which the sub-circuit VLC generates a voltage source loop in the circuit area 3p shown in FIG. 36. The sub-circuit VLC has voltage sources Vs and inductors Lt. In on-the-fly simulation, the corresponding stored resulting data in a required time slot is given to the external nodes N1 to NN. It is supposed that the given stored resulting data is the data equivalent to the data of voltage sources VN1 to VNN. Between the ground potentials GND connected to the voltage sources VN1 to VNN and the ground potential GND connected to the sub-circuit VLC, a closed circuit formed only of the voltage sources or the inductors, that is, a voltage source loop VLP is formed. When there is a voltage source loop in simulation, it is likely to generate such a defect that a contradiction is generated in the voltage of nodes included in that path or no current value can obtained.

A Simulation Result Might not be Obtained

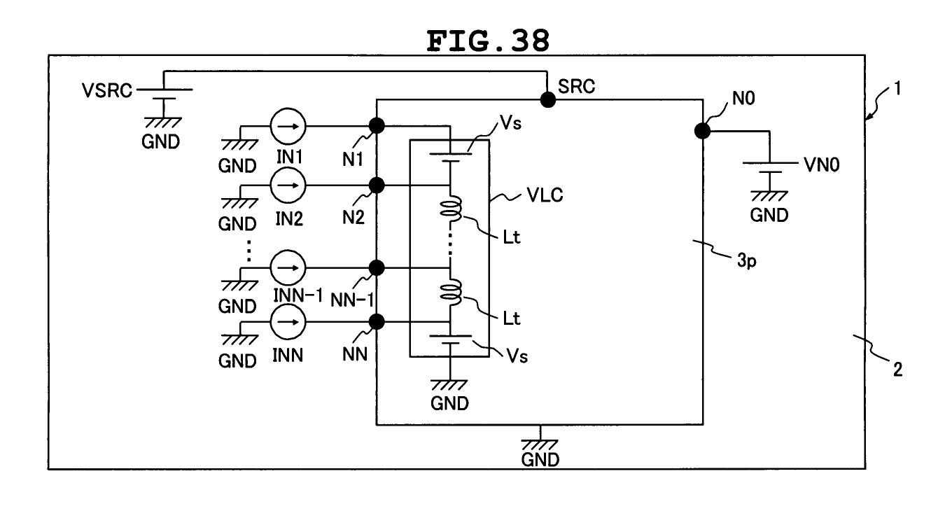

FIG. 38 shows an exemplary circuit state which suppresses the generation of a voltage source loop in on-the-fly simulation for the circuit area 3p shown in FIG. 36. When the state shown in FIG. 36 is detected, input/output information given to the external nodes N1 to NN in on-the-fly simulation is set to current information. More specifically, current sources IN1 to INN are connected to the external nodes N1 to NN. Thus, in simulation, even though there is a sub-circuit VLC as a circuit device in which at least only one device of the voltage source and the inductor is connected, the reference point of potential of the sub-circuit VLC is defined by the ground potential GND, and the current sources IN1 to INN are connected to the external nodes N1 to NN of the sub-circuit VLC, whereby the possibility is eliminated that a voltage source loop generated by providing voltage information to the external nodes N1 to NN is formed and objective on-the-fly simulation can be conducted for the circuit 3p including the sub-circuit VLC.

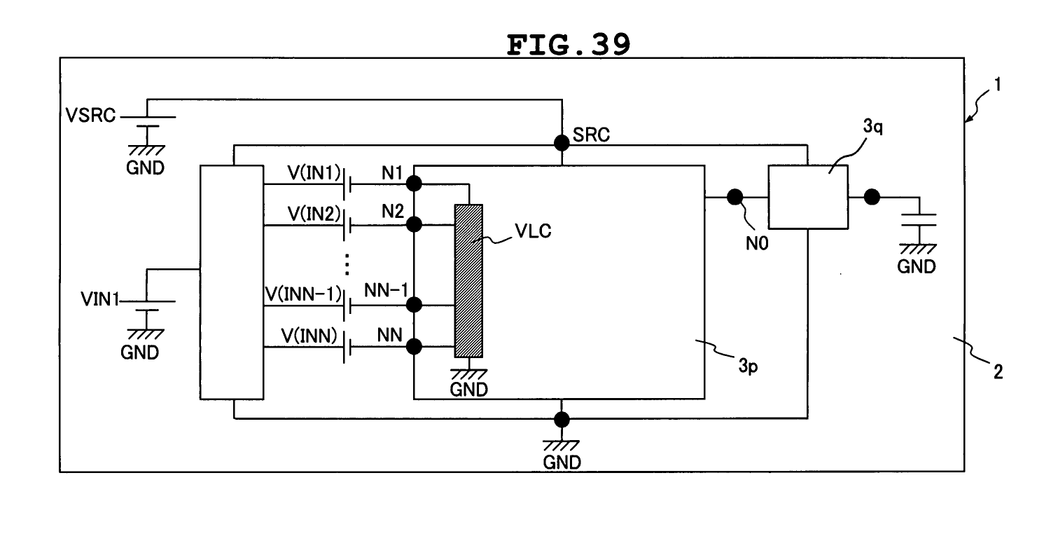

FIG. 39 shows a scheme to determine current information about the nodes N1 to NN. In other words, in simulation for the data storage area 2 in the simulation target circuit 1, voltage sources V (IN1) to V (INN) having zero voltage are added to the nodes N1 to NN as devices, and the values of the current carried through these devices are also stored as one item of resulting data 4. In on-the-fly simulation shown in FIG. 38, the current values of the current sources IN1 to INN may be given to the nodes N1 to NN. When the case is considered in which the example shown in FIG. 39 is adapted in an expanding manner, in addition to the case shown in FIG. 39, simulation resulting data for a plurality of required circuit nodes in the data storage area 2 may be stored as the voltage value and the current value. In a more expanding manner, it is convenient that the values of the voltage source and the current source that are not interfaced to the circuit node in the data storage area in the non data storage area 3 are stored as the initial conditions along with storing the data of the circuit simulation result for the data storage area. In this case, it may be more convenient that the current value of the voltage source and the voltage value of the current source are stored as well.

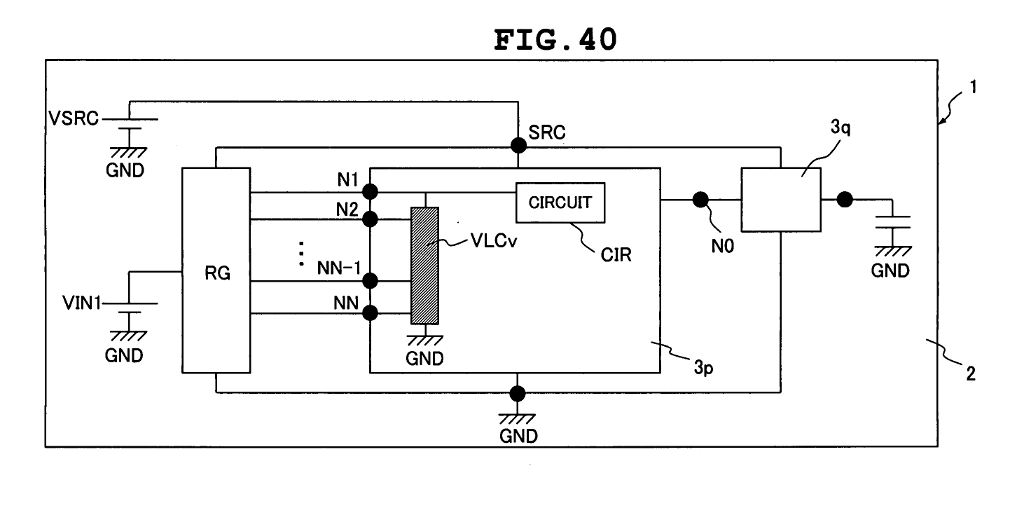

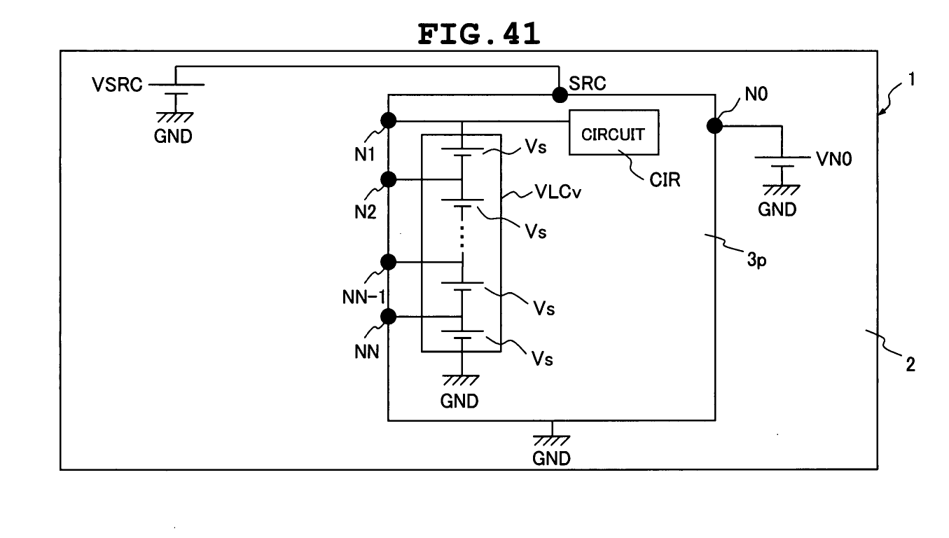

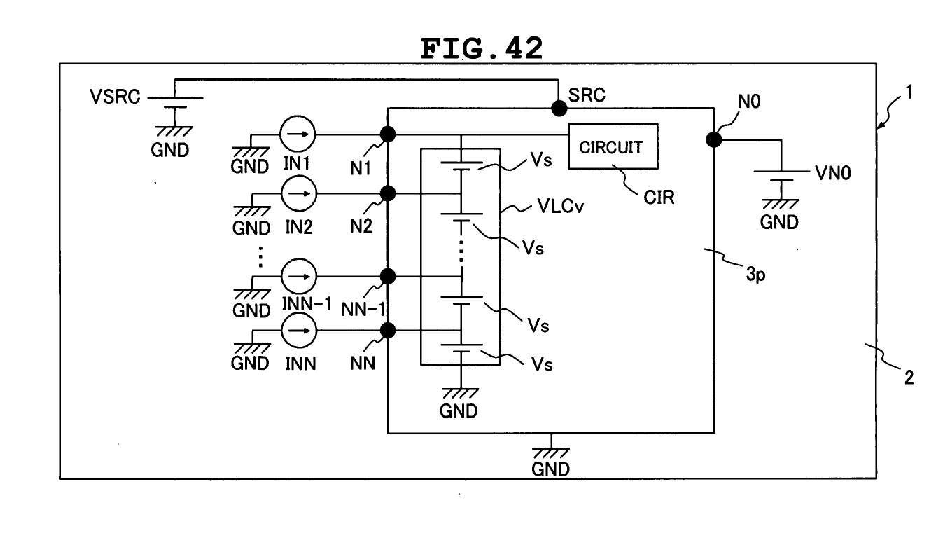

Next, a second example will be described. The case is considered in which a sub-circuit VLCv in a circuit area 3p is connected to another internal circuit CIR in addition to an external node N1 as shown in FIG. 40. It is supposed that the sub-circuit VLCV is configured of a single voltage source Vs or configured of two or more of voltage sources Vs joined to each other. The sub-circuit VLCV is connected to a ground potential as similar to the description above. When another circuit CIR is further connected to the sub-circuit VLCv, the values of the external nodes N1 to NN of the sub-circuit VLCv are decided depending on the state of that another circuit CIR. Thus, in on-the-fly simulation for the circuit area 3p, all the external nodes N1 to NN may be floated in the first place as shown in FIG. 41. This is done in order to generate no voltage source loop in any cases. When it is desired to verify the current carried through the voltage sources of the sub-circuit VLCv in on-the-fly simulation for the circuit area 3p, as exemplified in FIG. 42, current information as input/output information may be given to all the external nodes N1 to NN. The current information maybe determined as similar to the manner described above. From other viewpoints, it can be said that in the scheme shown in FIG. 41, all the external nodes may be floated when it is unnecessary to verify the current carried through the voltage sources of the sub-circuit VLCv by simulation.

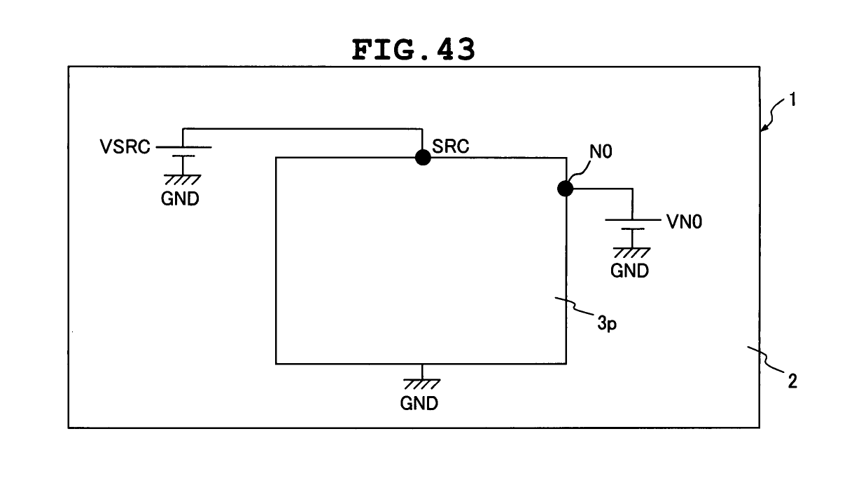

Next, a third example will be described. In the case in which the sub-circuit VLC is configured of any one device of a voltage source Vs and an inductor Lt or configured of at least two of devices having a voltage source Vs and an inductor Lt joined to each other, one or more of external nodes N1 to NN are disposed to connect the sub-circuit VLC to the outside, and the sub-circuit VLC is connected to the ground potential GND, when no current is observed that is carried through all the devices of the sub-circuit VLC in on-the-fly simulation for the circuit area 3p, the sub-circuit VLC is deleted to conduct on-the-fly simulation as shown in FIG. 43. In short, it can be said that the sub-circuit may be deleted to conduct simulation when it is unnecessary to verify the current carried through all the devices of the sub-circuit VLC by simulation. This contributes to a reduction in circuit information for simulation and a shortened computer processing time.

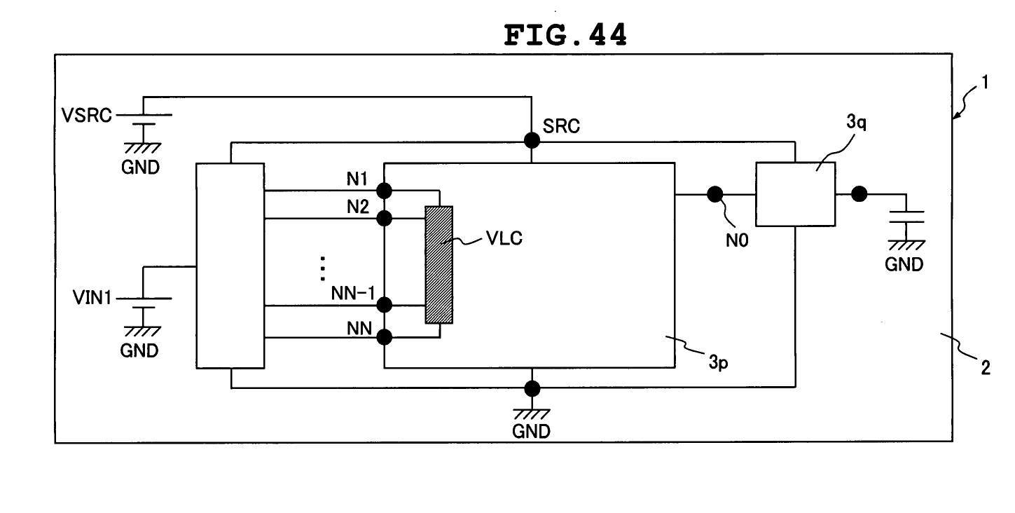

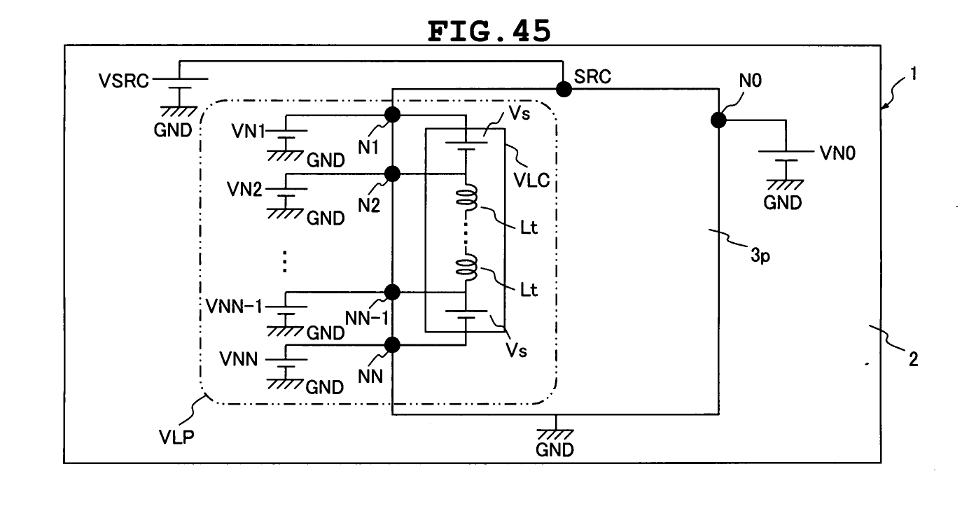

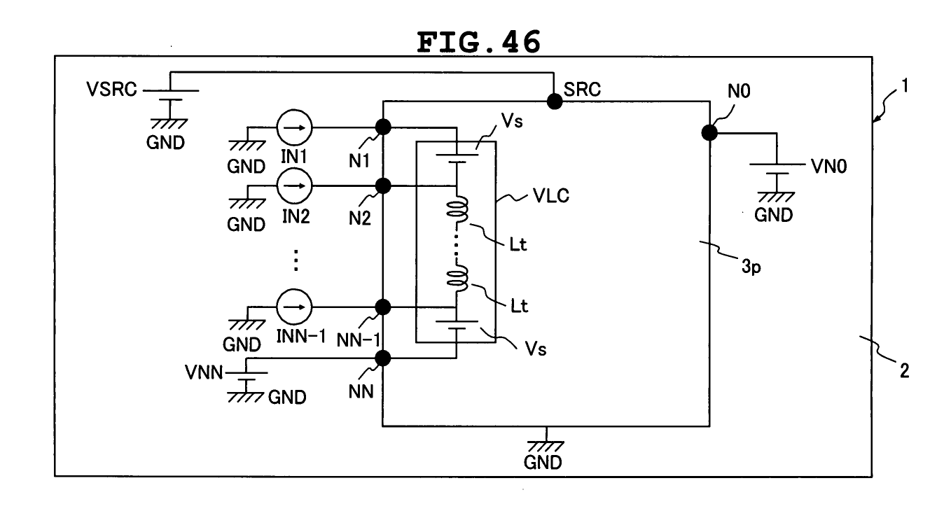

Next, a fourth example will be described. In the explanation above, it is supposed that the sub-circuit VLC is connected to the ground potential GND, but it is not necessarily connected thereto. A circuit shown in FIG. 44 is considered for that shown in FIG. 36. The difference from FIG. 36 is in that a sub-circuit VLC is not connected to a ground potential. At this time, when items of voltage source information VN1 to VNN are given to all of external nodes N1 to NN in on-the-fly simulation for a circuit area 3p as shown in FIG. 45, a voltage source loop VLP is formed as explained in FIG. 37. In order to suppress the generation of a voltage source loop, as shown in FIG. 46, in on-the-fly simulation for the circuit area 3p, input/output information to be given to one external node NN among the external nodes N1 to NN is set to voltage source information VNN, and input/output information to be given to the remaining external nodes N1 to NN-1 is set to items of current source information IN1 to INN-1. For example, the voltage source information VNN to be given to the external node NN as input/output information is considered to be information corresponding to the ground potential GND shown in FIG. 38. Thus, for the sub-circuit VLC which is not connected to the ground potential GND in the circuit area 3p, the reference point of potential is defined by the voltage source information VNN, and current sources IN1 to INN-1 are connected to the external nodes N1 to NN-1 of the sub-circuit VLC, whereby the possibility is eliminated that a voltage source loop generated by providing voltage information to the external nodes N1 to NN-1 is formed, and objective on-the-fly simulation can be conducted for the circuit area 3p including the sub-circuit VLC. In order to obtain the current source IN1 to INN-1 of the external nodes N1 to NN-1, the same scheme as that described in FIG. 39 may be used.

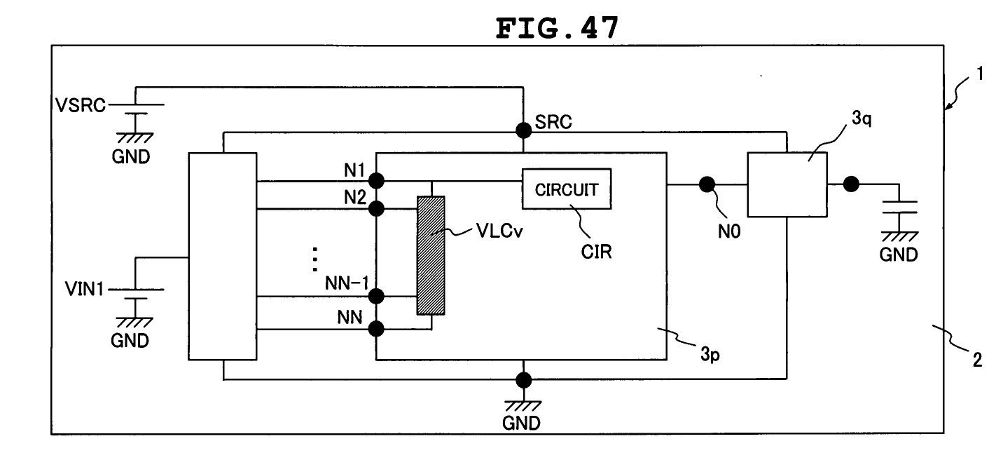

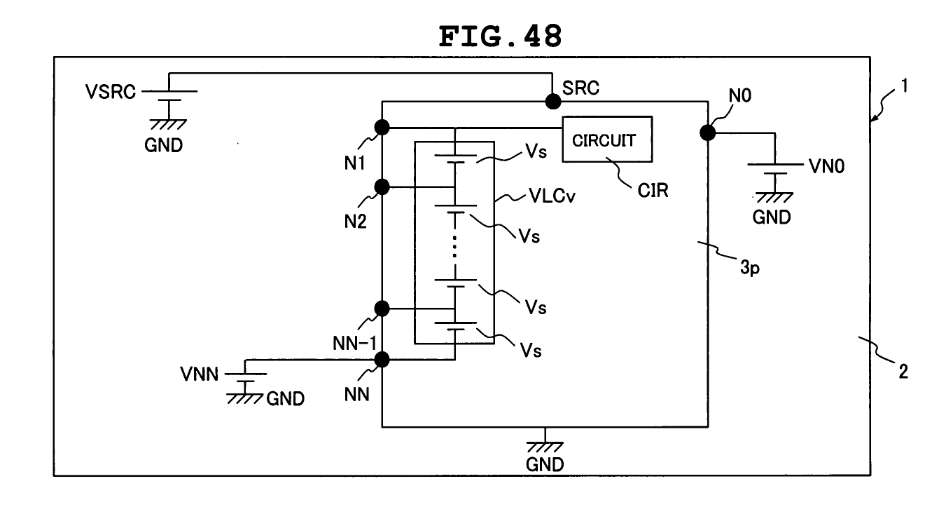

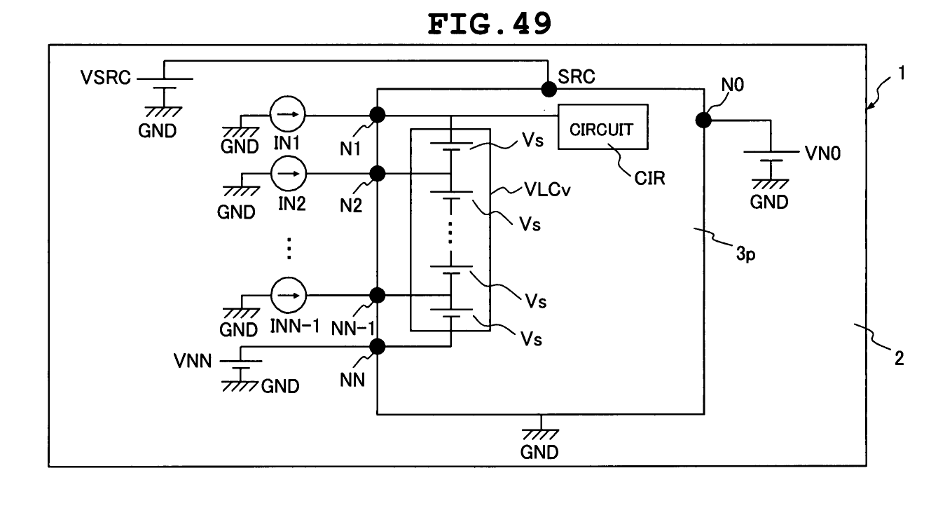

Next, a fifth example will be described. Also for the sub-circuit VLCv, the case is described in which it is connected to the ground potential GND, but it is not necessarily connected thereto. A circuit is considered as shown in FIG. 47 for that shown in FIG. 40. The difference from FIG. 40 is in that a sub-circuit VLCV is not connected to a ground potential GND. As described above, it is supposed that the sub-circuit VLCV is configured of a single voltage source Vs or configured of at least two of voltage sources Vs joined to each other. As exemplified in FIG. 48, in on-the-fly simulation for the circuit area 3p, input/output information to be given to one external node NN among the external nodes N1 to NN is set to voltage source information VNN, and the voltage source information VNN gives one of reference points of potential for the sub-circuit VLCv instead of the ground potential GND. When another circuit CIR is connected to the sub-circuit VLCv, the values of the external nodes N1 to NN-1 of the sub-circuit VLCv are decided depending on the state of that another circuit CIR. Therefore, in on-the-fly simulation for the circuit area 3p, as shown in FIG. 48, the other external nodes N1 to NN-1 may be floated except the external node NN. This is done in order to generate no voltage source loop in any cases. When it is desired to verify the current carried through the voltage sources Vs of the sub-circuit VLCv in on-the-fly simulation for the circuit area 3p, as exemplified in FIG. 49, current information as input/output information may be given to the other external nodes N1 to NN-1 except the input external node NN of voltage information VNN. The current information may be determined as similar to the description above. From different viewpoints, it can be said that in the scheme shown in FIG. 49, the external nodes may be floated except the input external node NN of voltage information VNN when it is unnecessary to verify the current carried through the voltage sources of the sub-circuit VLCv.

In addition, when the sub-circuit VLCv includes an inductor in the cases in FIGS. 40 and 48, the schemes in FIGS. 42 and 49 are effective as well. Since it is necessary to correctly reproduce the current when an inductor is included, the external nodes cannot be floated as shown in FIG. 48.

Next, a sixth example will be described. In the case in which the sub-circuit VCL is not connected to the ground potential as shown in FIG. 44, as similar to the third example, when the current carried through all the devices of the sub-circuit VLC is not observed in on-the-fly simulation for the circuit area 3p, the sub-circuit VLC may be deleted to conduct on-the-fly simulation as shown in FIG. 43. In short, it can be said that the sub-circuit may be deleted to conduct simulation when it is unnecessary to verify the current carried through all the devices of the sub-circuit VLC by simulation. This contributes to a reduction in circuit information for simulation and a shortened computer processing time.

According to the simulation method described above, even though all the items of simulation resulting data is not stored for a large-scale simulation target, the data of a given point to output a result can be shown, and a defect caused by a voltage source loop is hardly generated.

A small storage capacity can achieve the data showing performance equivalent to the case of storing all the items of simulation resulting data for a large-scale simulation target such as a large-scale integrated circuit, and a defect caused by a voltage source loop is hardly generated.

The speed of showing the simulation resulting data can be accelerated for a large-scale simulation target such as a large-scale integrated circuit, and a defect caused by a voltage source loop is hardly generated.

As described above, the invention made by the inventor has been described based on the examples more specifically, but the invention will not be limited thereto, which can be modified variously within the scope of the teachings not deviating therefrom.

For example, the scale of the simulation target circuit may be the scale of a few hundred thousands to a few millions of gates. In the description with reference to FIG. 19 and the other drawings, on-the-fly simulation is considered as the expansion of the function of showing the simulation result. However, it is of course possible to grasp the invention as partial simulation as separated from showing results. In the case of expanding the showing function, the invention is not limited to showing the simulation result, which can be grasped in the stance of showing data processing results for layered information.

Moreover, it is without saying that the simulation method can be grasped as a simulation program which implements the function or process procedures shown in the flow charts by using a computer. The simulation program like this is provided to allow easy implementation of the simulation method.

In addition, the simulation method according to the invention is not limited to circuit simulation, which can be adapted to device simulation as well. For example, in the case of device simulation in which a cross section of a device such as a MOS transistor is separated into mesh-like blocks to conduct simulation while it is grasped in layers, the result output point is a focused point of the current or the voltage on the cross section of the device, for example. In simulation for the higher level layer, the result output point exists in the border part between the meshes, whereas in simulation for the lower level layer, the result output point exists inside the mesh. When the result output point inside the mesh is to be obtained as the simulation result, partial device simulation may be conducted by using the existing simulation result of the existing result output point in the border part between the meshes and the same initial simulation condition as the condition when that existing result is obtained.

The invention can be adapted widely to circuit simulation for semiconductor integrated circuits, device simulation for semiconductor devices, etc.

What is claimed is:

1. A simulation method comprising:
a first process which conducts simulation in which a circuit node at a higher level layer of layered circuit data is set to a result output node and stores a result; and
a second process which uses a simulation result stored in the first process as input/output information about a circuit area including a circuit node at a lower level layer and conducts simulation for the circuit node at the lower level layer lower than the higher level layer,
wherein when a circuit area to be a target for the second process has a sub-circuit configured of any one device of a voltage source and an inductor or configured of at least two of devices having a voltage source and an inductor joined to each other and has one or more of external nodes which connect the sub-circuit to an outside, and when the sub-circuit is connected to a ground potential, input/output information to be given to the external node in the second process is set to current information.

2. A simulation method comprising:
a first process which conducts simulation in which a circuit node at a higher level layer of layered circuit data is set to a result output node and stores a result; and
a second process which uses a simulation result stored in the first process as input/output information about a circuit area including a circuit node at a lower level layer and conducts simulation for the circuit node at the lower level layer lower than the higher level layer,
wherein when a circuit area to be a target for the second process has a sub-circuit configured of a single voltage source or configured of at least two of voltage sources joined to each other, one or more of external nodes which connect the sub-circuit to an outside and another circuit connected to the sub-circuit, and when the sub-circuit is connected to a ground potential, input/output information to be given to the external node in the second process is set to current information.

3. A simulation method comprising:
a first process which conducts simulation in which a circuit node at a higher level layer of layered circuit data is set to a result output node and stores a result; and
a second process which uses a simulation result stored in the first process as input/output information about a circuit area including a circuit node at a lower level layer and conducts simulation for the circuit node at the lower level layer lower than the higher level layer,
wherein when a circuit area to be a target for the second process has a sub-circuit configured of a single voltage source or configured of two of voltage sources joined to each other, one or more of external nodes which connect the sub-circuit to an outside and another circuit connected to the sub-circuit, and when the sub-circuit is connected to a ground potential, all the external nodes are floated when a current carried through the voltage source of the sub-circuit is not observed in the second process.

4. A simulation method comprising:
a first process which conducts simulation in which a circuit node at a higher level layer of layered circuit data is set to a result output node and stores a result; and
a second process which uses a simulation result stored in the first process as input/output information about a circuit area including a circuit node at a lower level layer and conducts simulation for the circuit node at the lower level layer lower than the higher level layer,
wherein when a circuit area to be a target for the second process has a sub-circuit configured of any one device of a voltage source and an inductor or configured of at least two of devices having a voltage source and an inductor joined to each other and has one or more of external nodes which connect the sub-circuit to an outside, and when the sub-circuit is connected to a ground potential, the sub-circuit is deleted when a current carried through all the devices of the sub-circuit is not observed in the second process.

5. A simulation method comprising:
a first process which conducts simulation in which a circuit node at a higher level layer of layered circuit data is set to a result output node and stores a result; and
a second process which uses a simulation result stored in the first process as input/output information about a circuit area including a circuit node at a lower level layer and conducts simulation for the circuit node at the lower level layer lower than the higher level layer,
wherein when a circuit area to be a target for the second process includes a sub-circuit configured of any one device of a voltage source and an inductor or configured of at least two of devices having a voltage source and an inductor joined to each other and includes two or more of external nodes which connect the sub-circuit to an outside, and when the sub-circuit is not connected to a ground potential, input/output information to be given to one of two or more of the external nodes in the second process is set to voltage source information, and input/output information to be given to the remaining external nodes is set to current source information.

6. A simulation method comprising:
a first process which conducts simulation in which a circuit node at a higher level layer of layered circuit data is set to a result output node and stores a result; and
a second process which uses a simulation result stored in the first process as input/output information about a circuit area including a circuit node at a lower level layer and conducts simulation for the circuit node at the lower level layer lower than the higher level layer,
wherein when a circuit area to be a target for the second process includes a sub-circuit configured of a single voltage source or configured of at least two of voltage sources joined to each other, two or more of the external nodes which connect the sub-circuit to an outside and another circuit connected to the sub-circuit, and when the sub-circuit is not connected to a ground potential, input/output information to be given to one of two or more of the external nodes in the second process is set to voltage source information, and input/output information to be given to the remaining external nodes is set to current source information.

7. A simulation method comprising:
a first process which conducts simulation in which a circuit node at a higher level layer of layered circuit data is set to a result output node and stores a result; and
a second process which uses a simulation result stored in the first process as input/output information about a circuit area including a circuit node at a lower level layer and conducts simulation for the circuit node at the lower level layer lower than the higher level layer,
wherein when a circuit area to be a target for the second process includes a sub-circuit configured of a single voltage source or configured of two or more of voltage sources joined to each other, two or more of the external nodes which connect the sub-circuit to an outside and another circuit connected to the sub-circuit, and when the sub-circuit is not connected to a ground potential, input/output information to be given to one external node is set to voltage source information, and the remaining external nodes are floated when a current carried through the voltage source of the sub-circuit is not observed in the second process.

8. A simulation method comprising:
a first process which conducts simulation in which a circuit node at a higher level layer of layered circuit data is set to a result output node and stores a result; and
a second process which uses a simulation result stored in the first process as input/output information about a circuit area including a circuit node at a lower level layer and conducts simulation for the circuit node at the lower level layer lower than the higher level layer,
wherein when a circuit area to be a target for the second process has a sub-circuit configured of any one device of a voltage source and an inductor or configured of at least two of devices having a voltage source and an inductor joined to each other and has one or more of external nodes which connect the sub-circuit to an outside, and when the sub-circuit is not connected to a ground potential, the sub-circuit is deleted when a current carried through all the devices of the sub-circuit is not observed in the second process.

9. The simulation method according to claim 1, wherein in the first process, when a value of the voltage source or the current source to be connected to the result output node depends on a value of a circuit node or a state of a circuit device at a lower level layer, information about the value of the circuit node or the circuit device at the lower level layer is also stored.

10. A simulation method comprising:
an extracting process which extracts a circuit node at a specified higher level layer from layered circuit data;
a simulation execution process which conducts circuit simulation in which a circuit node extracted in the extracting process is set to a result output node;
a storage process which stores resulting data obtained at the result output node by the simulation execution process; and
a simulation re-execution process which acquires input/output information that is done outside a circuit area including a circuit node from the stored resulting data for the circuit node at a lower level layer than the specified layer and conducts circuit simulation,
wherein when a circuit area to be a target for the simulation re-execution process has a sub-circuit configured of any one device of a voltage source and an inductor or configured of at least two of devices having a voltage source and an inductor joined to each other and has one or more of external nodes which connect the sub-circuit to an outside, and when the sub-circuit is connected to a ground potential, input/output information to be given to the external node in the simulation re-execution process is set to current information.

11. A simulation method comprising:
an extracting process which extracts a circuit node at a specified higher level layer from layered circuit data;
a simulation execution process which conducts circuit simulation in which a circuit node extracted in the extracting process is set to a result output node;
a storage process which stores resulting data obtained at the result output node by the simulation execution process; and
a simulation re-execution process which acquires input/output information that is done outside a circuit area including a circuit node from the stored resulting data for the circuit node at a lower level layer than the specified layer and conducts circuit simulation,
wherein when a circuit area to be a target for the simulation re-execution process has a sub-circuit configured of a single voltage source or configured of at least two of voltage sources joined to each other, one or more of external nodes which are connected to the sub-circuit, and another circuit which connects the sub-circuit to an outside, and when the sub-circuit is connected to a ground potential, input/output information to be given to the external node in the simulation re-execution process is set to current information.

12. A simulation method comprising:
an extracting process which extracts a circuit node at a specified higher level layer from layered circuit data;
a simulation execution process which conducts circuit simulation in which a circuit node extracted in the extracting process is set to a result output node;
a storage process which stores resulting data obtained at the result output node by the simulation execution process; and
a simulation re-execution process which acquires input/output information that is done outside a circuit area including a circuit node from the stored resulting data for the circuit node at a lower level layer than the specified layer and conducts circuit simulation,
wherein when a circuit area to be a target for the simulation re-execution process has a sub-circuit configured of a single voltage source or configured of two or more of voltage sources joined to each other, one or more of external nodes which are connected to the sub-circuit, and another circuit which connects the sub-circuit to an outside, and when the sub-circuit is connected to a ground potential, all the external nodes are floated when a current carried through the voltage source of the sub-circuit is not observed in the simulation re-execution process.

13. A simulation method comprising:
an extracting process which extracts a circuit node at a specified higher level layer from layered circuit data;
a simulation execution process which conducts circuit simulation in which a circuit node extracted in the extracting process is set to a result output node;
a storage process which stores resulting data obtained at the result output node by the simulation execution process; and
a simulation re-execution process which acquires input/output information that is done outside a circuit area including a circuit node from the stored resulting data for the circuit node at a lower level layer than the specified layer and conducts circuit simulation,
wherein when a circuit area to be a target for the simulation re-execution process has a sub-circuit configured of any one device of a voltage source and an inductor or configured of at least two of devices having a voltage source and an inductor joined to each other and has one or more of external nodes which connect the sub-circuit to an outside, and when the sub-circuit is not connected to a ground potential, the sub-circuit is deleted when a current carried through all the devices of the sub-circuit is not observed in the simulation re-execution process.

14. A simulation method comprising:
an extracting process which extracts a circuit node at a specified higher level layer from layered circuit data;
a simulation execution process which conducts circuit simulation in which a circuit node extracted in the extracting process is set to a result output node;
a storage process which stores resulting data obtained at the result output node by the simulation execution process; and
a simulation re-execution process which acquires input/output information that is done outside a circuit area including a circuit node from the stored resulting data for the circuit node at a lower level layer than the specified layer and conducts circuit simulation,
wherein when a circuit area to be a target for the simulation re-execution process includes a sub-circuit configured of any one device of a voltage source and an inductor or configured of at least two of devices having a voltage source and an inductor joined to each other and includes two or more of the external nodes which connect the sub-circuit to an outside, and when the sub-circuit is not connected to a ground potential, input/output information to be given to one of two or more of the external nodes in the simulation re-execution process is set to voltage source information and input/output information to be given to the remaining external nodes is set to current source information.

15. A simulation method comprising:
an extracting process which extracts a circuit node at a specified higher level layer from layered circuit data;
a simulation execution process which conducts circuit simulation in which a circuit node extracted in the extracting process is set to a result output node;
a storage process which stores resulting data obtained at the result output node by the simulation execution process; and
a simulation re-execution process which acquires input/output information that is done outside a circuit area including a circuit node from the stored resulting data for the circuit node at a lower level layer than the specified layer and conducts circuit simulation,
wherein when a circuit area to be a target for the simulation re-execution process includes a sub-circuit configured of a single voltage source or configured of at least two of voltage sources joined to each other, two of the external nodes which connect the sub-circuit to an outside and another circuit connected to the sub-circuit, and when the sub-circuit is not connected to a ground potential, input/output information to be given to one of two or more of the external nodes in the simulation re-execution process is set to voltage source information, and input/output information to be given to the remaining external nodes is set to current source information.

16. A simulation method comprising:
an extracting process which extracts a circuit node at a specified higher level layer from layered circuit data;
a simulation execution process which conducts circuit simulation in which a circuit node extracted in the extracting process is set to a result output node;
a storage process which stores resulting data obtained at the result output node by the simulation execution process; and
a simulation re-execution process which acquires input/output information that is done outside a circuit area including a circuit node from the stored resulting data for the circuit node at a lower level layer than the specified layer and conducts circuit simulation,
wherein when a circuit area to be a target for the simulation re-execution process includes a sub-circuit configured of a single voltage source or configured of two or more of voltage sources joined to each other, two or more of the external nodes which connect the sub-circuit to an outside and another circuit connected to the sub-circuit, and when the sub-circuit is not connected to a ground potential, input/output information to be given to one external node is set to voltage source information, and the remaining external nodes are floated when a current carried through the voltage source of the sub-circuit is not observed in the simulation re-execution process.

17. A simulation method comprising:
an extracting process which extracts a circuit node at a specified higher level layer from layered circuit data;
a simulation execution process which conducts circuit simulation in which a circuit node extracted in the extracting process is set to a result output node;
a storage process which stores resulting data obtained at the result output node by the simulation execution process; and
a simulation re-execution process which acquires input/output information that is done outside a circuit area including a circuit node from the stored resulting data for the circuit node at a lower level layer than the specified layer and conducts circuit simulation,
wherein when a circuit area to be a target for the simulation re-execution process has a sub-circuit configured of any one device of a voltage source and an inductor or configured of at least two of devices having a voltage source and an inductor joined to each other and has one or more of external nodes which connect the sub-circuit to an outside, and when the sub-circuit is not connected to a ground potential, the sub-circuit is deleted when a current carried through all the devices of the sub-circuit is not observed in the simulation re-execution process.

18. The simulation method according to claim 10, wherein simulation in the simulation re-execution process is conducted under an initial condition equivalent to that of simulation in the simulation execution process.

19. The simulation method according to claim 10, further comprising a showing process which shows resulting data stored in the storage process or a simulation result obtained in the simulation re-execution process in response to an instruction to show a result from simulation processing.

20. The simulation method according to claim 10, wherein the extracting process is a process which conducts a process for all reference lines in a simulation target, the process being to register a circuit node trackable at a set layer level at every time when the setting of a layer level is changed to a lower level while a reference line to a lower layer is followed in layered circuit data.

21. The simulation method according to claim 5, wherein when a value of the voltage source or the current source to be connected to the result output node depends on a value of a circuit node or a state of a circuit device at a lower level layer, the storage process further stores information about the value of the circuit node or circuit device at the lower level layer.

22. A simulation method comprising:
a simulation execution process which uses layered circuit data to conduct a circuit simulation process;
a storage process which stores resulting data obtained at a predetermined circuit node by the simulation execution process; and
a simulation re-execution process which acquires input/output information that is done outside a circuit area including a circuit node from resulting data stored in the storage process for the circuit node that its state is changed by alteration when the layered circuit data is altered, and conducts circuit simulation,
wherein when a circuit area to be a target for the simulation re-execution process has a sub-circuit configured of any one device of a voltage source and an inductor or configured of at least two of devices having a voltage source and an inductor joined to each other and has one or more of external nodes which connect the sub-circuit to an outside, and when the sub-circuit is connected to a ground potential, input/output information to be given to the external node in the simulation re-execution process is set to current information.

23. A simulation method comprising:
a simulation execution process which uses layered circuit data to conduct a circuit simulation process;
a storage process which stores resulting data obtained at a predetermined circuit node by the simulation execution process; and
a simulation re-execution process which acquires input/output information that is done outside a circuit area including a circuit node from resulting data stored in the storage process for the circuit node that its state is changed by alteration when the layered circuit data is altered, and conducts circuit simulation,
wherein a circuit area to be a target for the simulation re-execution process has a sub-circuit configured of a single voltage source or configured of at least two of voltage sources joined to each other, one or more of external nodes which connect the sub-circuit to an outside and another circuit connected to the sub-circuit, and when the sub-circuit is connected to a ground potential, input/output information to be given to the external node in the simulation re-execution process is set to current information.

24. A simulation method comprising:
a simulation execution process which uses layered circuit data to conduct a circuit simulation process;
a storage process which stores resulting data obtained at a predetermined circuit node by the simulation execution process; and
a simulation re-execution process which acquires input/output information that is done outside a circuit area including a circuit node from resulting data stored in the storage process for the circuit node that its state is changed by alteration when the layered circuit data is altered, and conducts circuit simulation,
wherein when a circuit area to be a target for the simulation re-execution process has a sub-circuit configured of a single voltage source or configured of two or more of voltage sources joined to each other, one or more of external nodes which connect the sub-circuit to an outside and another circuit connected to the sub-circuit, and when the sub-circuit is connected to a ground potential, all the external nodes are floated when a current carried through the voltage source of the sub-circuit is not observed in the simulation re-execution process.

25. A simulation method comprising:
a simulation execution process which uses layered circuit data to conduct a circuit simulation process;
a storage process which stores resulting data obtained at a predetermined circuit node by the simulation execution process; and
a simulation re-execution process which acquires input/output information that is done outside a circuit area including a circuit node from resulting data stored in the storage process for the circuit node that its state is changed by alteration when the layered circuit data is altered, and conducts circuit simulation,
wherein when a circuit area to be a target for the simulation re-execution process has a sub-circuit configured of any one device of a voltage source and an inductor or configured of at least two of devices having a voltage source and an inductor joined to each other and has one or more of external nodes which connect the sub-circuit to an outside, and when the sub-circuit is connected to a ground potential, the sub-circuit is deleted when a current carried through all the devices of the sub-circuit is not observed in the simulation re-execution process.

26. A simulation method comprising:
a simulation execution process which uses layered circuit data to conduct a circuit simulation process;
a storage process which stores resulting data obtained at a predetermined circuit node by the simulation execution process; and
a simulation re-execution process which acquires input/output information that is done outside a circuit area including a circuit node from resulting data stored in the storage process for the circuit node that its state is changed by alteration when the layered circuit data is altered, and conducts circuit simulation,
wherein when a circuit area to be a target for the simulation re-execution process includes a sub-circuit configured of any one device of a voltage source and an inductor or configured of at least two of devices having a voltage source and an inductor joined to each other and includes two or more of the external nodes which connect the sub-circuit to an outside, and when the sub-circuit is not connected to a ground potential, input/output information to be given to one of two or more of the external nodes in the simulation re-execution process is set to voltage source information, and input/output information to be given to the remaining external nodes is set to current source information.

27. A simulation method comprising:
a simulation execution process which uses layered circuit data to conduct a circuit simulation process;
a storage process which stores resulting data obtained at a predetermined circuit node by the simulation execution process; and
a simulation re-execution process which acquires input/output information that is done outside a circuit area including a circuit node from resulting data stored in the storage process for the circuit node that its state is changed by alteration when the layered circuit data is altered, and conducts circuit simulation,
wherein when a circuit area to be a target for the simulation re-execution process includes a sub-circuit configured of a single voltage source or configured of at least two of voltage sources joined to each other, two or more of the external nodes which connect the sub-circuit to an outside and another circuit connected to the sub-circuit, and when the sub-circuit is not connected to a ground potential, input/output information to be given to one of two or more of the external nodes in the simulation re-execution process is set to voltage source information, and input/output information to be given to the remaining external nodes is set to current source information.

28. A simulation method comprising:
a simulation execution process which uses layered circuit data to conduct a circuit simulation process;
a storage process which stores resulting data obtained at a predetermined circuit node by the simulation execution process; and
a simulation re-execution process which acquires input/output information that is done outside a circuit area including a circuit node from resulting data stored in the storage process for the circuit node that its state is changed by alteration when the layered circuit data is altered, and conducts circuit simulation,
wherein when a circuit area to be a target for the simulation re-execution process includes a sub-circuit configured of a single voltage source or configured of two or more of voltage sources joined to each other, two or more of the external nodes connected to the sub-circuit and another circuit which connects the sub-circuit to an outside, and when the sub-circuit is not connected to a ground potential, input/output information to be given to one external node is set to voltage source information, and the remaining external nodes are floated when a current carried through the voltage source of the sub-circuit is not observed in the simulation re-execution process.

29. A simulation method comprising:
a simulation execution process which uses layered circuit data to conduct a circuit simulation process;
a storage process which stores resulting data obtained at a predetermined circuit node by the simulation execution process; and
a simulation re-execution process which acquires input/output information that is done outside a circuit area including a circuit node from resulting data stored in the storage process for the circuit node that its state is changed by alteration when the layered circuit data is altered, and conducts circuit simulation,
wherein when a circuit area to be a target for the simulation re-execution process has a sub-circuit configured of any one device of a voltage source and an inductor or configured of at least two of devices having a voltage source and an inductor joined to each other and has one or more of external nodes which connect the sub-circuit to an outside, and when the sub-circuit is not connected to a ground potential, the sub-circuit is deleted when a current carried through all the devices of the sub-circuit is not observed in the simulation re-execution process.

30. The simulation method according to claim 22, wherein in the simulation re-execution process, circuit simulation is conducted in parallel for each sub-area in which signal paths are independent of each other in the circuit area.

31. A simulation method comprising:
a first process which extracts a result output point at a specified higher level layer from a simulation target;
a second process which conducts simulation relating to the extracted result output point;
a third process which stores resulting data obtained at the result output point in the second process; and
a fourth process which acquires border information about an area including the result output point at the lower level layer from resulting data stored in the third process in response to an instruction to show a result from simulation processing for a lower level layer than the specified layer, and conducts simulation in order to obtain a result output at the lower level layer under an initial condition equivalent to that of simulation in the second process,
wherein when an area including the result output point at the lower level layer to be a target for the fourth process has a sub-circuit configured of any one device of a voltage source and an inductor or configured of at least two of devices having a voltage source and an inductor joined to each other and has one or more of external nodes which connect the sub-circuit to an outside, and when the sub-circuit is connected to the ground potential, input/output information to be given to the external node in the fourth process is set to current information.

32. A simulation method comprising:
a first process which extracts a result output point at a specified higher level layer from a simulation target;
a second process which conducts simulation relating to the extracted result output point;
a third process which stores resulting data obtained at the result output point in the second process; and
a fourth process which acquires border information about an area including the result output point at the lower level layer from resulting data stored in the third process in response to an instruction to show a result from simulation processing for a lower level layer than the specified layer, and conducts simulation in order to obtain a result output at the lower level layer under an initial condition equivalent to that of simulation in the second process,
wherein when an area including the result output point at the lower level layer to be a target for the fourth process has a sub-circuit configured of a single voltage source or configured of at least two of voltage sources joined to each other, one or more of external nodes which connect the sub-circuit to an outside and another circuit connected to the sub-circuit, and when the sub-circuit is connected to a ground potential, input/output information to be given to the external node in the fourth process is set to current information.

33. A simulation method comprising:
a first process which extracts a result output point at a specified higher level layer from a simulation target;
a second process which conducts simulation relating to the extracted result output point;
a third process which stores resulting data obtained at the result output point in the second process; and
a fourth process which acquires border information about an area including the result output point at the lower level layer from resulting data stored in the third process in response to an instruction to show a result from simulation processing for a lower level layer than the specified layer, and conducts simulation in order to obtain a result output at the lower level layer under an initial condition equivalent to that of simulation in the second process,
wherein when an area including the result output point at the lower level layer to be a target for the fourth process the circuit area has a sub-circuit configured of a single voltage source or configured of two or more of voltage sources joined to each other, one or more of external nodes which connect the sub-circuit to an outside and another circuit connected to the sub-circuit, and when the sub-circuit is connected to a ground potential, all the external nodes are floated when a current carried through the voltage source of the sub-circuit is not observed in the fourth process.

34. A simulation method comprising:
a first process which extracts a result output point at a specified higher level layer from a simulation target;
a second process which conducts simulation relating to the extracted result output point;
a third process which stores resulting data obtained at the result output point in the second process; and
a fourth process which acquires border information about an area including the result output point at the lower level layer from resulting data stored in the third process in response to an instruction to show a result from simulation processing for a lower level layer than the specified layer, and conducts simulation in order to obtain a result output at the lower level layer under an initial condition equivalent to that of simulation in the second process,
wherein when an area including the result output point at the lower level layer to be a target for the fourth process the circuit area has a sub-circuit configured of any one device of a voltage source and an inductor or configured of at least two of devices having a voltage source and an inductor joined to each other and has one or more of external nodes which connect the sub-circuit to an outside, and when the sub-circuit is connected to a ground potential, the sub-circuit is deleted when a current carried through all the devices of the sub-circuit is not observed in the fourth process.

35. A simulation method comprising:
a first process which extracts a result output point at a specified higher level layer from a simulation target;
a second process which conducts simulation relating to the extracted result output point;
a third process which stores resulting data obtained at the result output point in the second process; and
a fourth process which acquires border information about an area including the result output point at the lower level layer from resulting data stored in the third process in response to an instruction to show a result from simulation processing for a lower level layer than the specified layer, and conducts simulation in order to obtain a result output at the lower level layer under an initial condition equivalent to that of simulation in the second process,
wherein when a circuit area to be a target for the simulation re-execution process includes a sub-circuit configured of any one device of a voltage source and an inductor or configured of at least two of devices having a voltage source and an inductor joined to each other and has two or more of the external nodes which connect the sub-circuit to an outside, and when the sub-circuit is not connected to a ground potential, input/output information to be given to one of two or more of the external nodes in the fourth process is set to voltage source information, and input/output information to be given to the remaining external nodes is set to current source information.

36. A simulation method comprising:
a first process which extracts a result output point at a specified higher level layer from a simulation target;
a second process which conducts simulation relating to the extracted result output point;
a third process which stores resulting data obtained at the result output point in the second process; and
a fourth process which acquires border information about an area including the result output point at the lower level layer from resulting data stored in the third process in response to an instruction to show a result from simulation processing for a lower level layer than the specified layer, and conducts simulation in order to obtain a result output at the lower level layer under an initial condition equivalent to that of simulation in the second process,
wherein when an area including the result output point at the lower level layer to be a target for the fourth process includes a sub-circuit configured of a single voltage source or configured of at least two of voltage sources joined to each other, two or more of the external nodes which connect the sub-circuit to an outside and another circuit connected to the sub-circuit, and when the sub-circuit is not connected to a ground potential, input/output information to be given to one of two or more of the external nodes in the fourth process is set to voltage source information, and input/output information to be given to the remaining external nodes is set to current source information.

37. A simulation method comprising:
a first process which extracts a result output point at a specified higher level layer from a simulation target;
a second process which conducts simulation relating to the extracted result output point;
a third process which stores resulting data obtained at the result output point in the second process; and
a fourth process which acquires border information about an area including the result output point at the lower level layer from resulting data stored in the third process in response to an instruction to show a result from simulation processing for a lower level layer than the specified layer, and conducts simulation in order to obtain a result output at the lower level layer under an initial condition equivalent to that of simulation in the second process,
wherein when an area including the result output point at the lower level layer to be a target for the fourth process includes a sub-circuit configured of a single voltage source or configured of two or more of voltage sources joined to each other, two or more of the external nodes which connect the sub-circuit to an outside and another circuit connected to the sub-circuit, and when the sub-circuit is not connected to a ground potential, input/output information to be given to one external node is set to voltage source information, and the remaining external nodes are floated when a current carried through a voltage source of the sub-circuit is not observed in the fourth process.

38. A simulation method comprising:
a first process which extracts a result output point at a specified higher level layer from a simulation target;
a second process which conducts simulation relating to the extracted result output point;
a third process which stores resulting data obtained at the result output point in the second process; and
a fourth process which acquires border information about an area including the result output point at the lower level layer from resulting data stored in the third process in response to an instruction to show a result from simulation processing for a lower level layer than the specified layer, and conducts simulation in order to obtain a result output at the lower level layer under an initial condition equivalent to that of simulation in the second process,
wherein when an area including the result output point at the lower level layer to be a target for the fourth process the circuit area has a sub-circuit configured of any one device of a voltage source and an inductor or configured of at least two of devices having a voltage source and an inductor joined to each other and has one or more of external nodes which connect the sub-circuit to an outside, and when the sub-circuit is not connected to a ground potential, the sub-circuit is deleted when a current carried through all the devices of the sub-circuit is not observed in the fourth process.

39. The simulation method according to claim 31, wherein when a value of the voltage source or the current source to be connected to the result output point depends on a value of a circuit node or a state of a circuit device at a lower level layer, the third process further stores information about the value of the circuit node or circuit device at the lower level layer.
